(19) United States
(12) Patent Application Publication
(10) Pub. No.: US 2026/0073239 A1
(43) Pub. Date: Mar. 12, 2026

(54) ARTIFICIAL INTELLIGENCE AIDED DATA COLLECTION IN WIRELESS SYSTEMS

(71) Applicant: Samsung Electronics Co., Ltd., Suwon-si (KR)

(72) Inventors: Xinliang Zhang, Plano, TX (US); Jianhua Mo, Allen, TX (US); Young Han Nam, Plano, TX (US)

(21) Appl. No.: 19/317,092

(22) Filed: Sep. 2, 2025

Related U.S. Application Data
(60) Provisional application No. 63/693,551, filed on Sep. 11, 2024.

(51) Int. Cl. G06N 3/0985; G06N 3/0475; G06N 3/063; G06N 3/094

(52) U.S. Cl. CPC G06N 3/0985; G06N 3/0475; G06N 3/063; G06N 3/094

(57) ABSTRACT

A method includes: transmitting, by a first electronic device, a data collection capability report to a second electronic device in response to a request, the data collection capability report including identifications of associated artificial intelligence (AI) models and key performance indicators (KPIs) that each of the AI models is capable of evaluating; receiving, by the first electronic device, a data collection configuration message from the second electronic device, the data collection configuration message including an enablement status for each of the KPIs; receiving, by the first electronic device, a data collection request from the second electronic device, the data collection request including a collection condition configuration associated with each of the KPIs; and collecting, by the first electronic device, data samples based on the collection condition configuration to generate and transfer a data package including collected data samples satisfying the collection condition configuration.

### CROSS-REFERENCE TO RELATED APPLICATION AND CLAIM OF PRIORITY

The present application claims priority under 35 U.S. C. § 119(e) to U.S. Provisional Patent Application No. 63/693,551 filed on Sep. 11, 2024, which is hereby incorporated by reference in its entirety.

### TECHNICAL FIELD

This disclosure relates generally to wireless communication systems. More specifically, this disclosure relates to apparatuses and methods for artificial intelligence (AI) aided data collection in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides AI aided data collection methods and apparatuses in wireless communication systems.

In one embodiment, a method is provided. The method includes: transmitting, by a first electronic device, a data collection capability report to a second electronic device in response to a request, the data collection capability report including identifications (IDs) of associated artificial intelligence (AI) models and key performance indicators (KPIs) that each of the AI models is capable of evaluating; receiving, by the first electronic device, a data collection configuration message from the second electronic device, the data collection configuration message including an enablement status for each of the KPIs; receiving, by the first electronic device, a data collection request from the second electronic device, the data collection request including a collection condition configuration associated with each of the KPIs; and collecting, by the first electronic device, data samples based on the collection condition configuration to generate and transfer a data package including collected data samples satisfying the collection condition configuration.

In another embodiment, a first electric device includes: a memory and a processor operably coupled to the memory. The processor is configured to: transmit a data collection capability report to a second electronic device in response to a request, the data collection capability report including IDs of associated AI models and KPIs that each of the AI models is capable of evaluating; receive a data collection configuration message from the second electronic device, the data collection configuration message including an enablement status for each of the KPIs; receive a data collection request from the second electronic device, the data collection request including a collection condition configuration associated with each of the KPIs; and collect data samples based on the collection condition configuration to generate and transfer a data package including collected data samples satisfying the collection condition configuration.

In yet another embodiment, a non-transitory computer readable medium embodying a computer program is provided. The computer program includes program code that, when executed by a processor of a first electronic device, causes the first electronic device to: transmit a data collection capability report to a second electronic device in response to a request, the data collection capability report including IDs of associated AI models and KPIs that each of the AI models is capable of evaluating; receive a data collection configuration message from the second electronic device, the data collection configuration message including an enablement status for each of the KPIs; receive a data collection request from the second electronic device, the data collection request including a collection condition configuration associated with each of the KPIs; and collect data samples based on the collection condition configuration to generate and transfer a data package including collected data samples satisfying the collection condition configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example base station according to embodiments of the present disclosure;

FIG. 3 illustrates an example user equipment according to embodiments of the present disclosure;

FIG. 4 illustrates an example network device according to embodiment of the present disclosure;

FIG. 5 illustrates an example architecture of an open radio access network according to embodiments of the present disclosure;

FIG. 6 illustrates an example architecture of an AI-aided data collection method in wireless communication systems according to embodiments of the present disclosure;

FIG. 7 illustrates an example signaling process for the AI-aided data collection method according to embodiments of the present disclosure;

FIG. 8A illustrates an example an example AI data collection capability report according to embodiments of the present disclosure;

FIG. 8B illustrates an example data collection configuration message in accordance with example embodiments of the present disclosure;

FIG. 9 illustrates an example data collection request according to embodiments of the present disclosure;

FIGS. 10A-10D illustrate example collection time window configurations according to embodiments of the present disclosure;

FIG. 11 illustrates an example data collection termination request according to embodiments of the present disclosure;

FIG. 12 illustrates an example collection condition list configuration according to embodiments of the present disclosure;

FIG. 13 illustrates an example data collection request according to embodiments of the present disclosure;

FIGS. 14A-14C illustrate example data collection scenarios in accordance with example embodiments of the present disclosure;

FIG. 15 illustrates an example conditional data collection unit of an AI-aided data collection architecture according to embodiments of the present disclosure;

FIG. 16 illustrates an example data collection scenario using the conditional data collection unit of FIG. 15 according to embodiments of the present disclosure;

FIG. 17 illustrates an example flow diagram of AI-aided data collection method using data collection condition evaluation modules according to embodiments of the present disclosure;

FIGS. 18A-18C illustrate example scenarios in which all or some of the evaluation modules of FIG. 17 are configured according to embodiments of the present disclosure;

FIG. 19 illustrates an example signaling process using the conditional data collection unit of FIG. 15 according to embodiments of the present disclosure;

FIG. 20A illustrates an example AI data collection capability report in accordance with example embodiments of the present disclosure;

FIG. 20B illustrates example tags for data collection condition evaluation in accordance with example embodiments of the present disclosure;

FIGS. 21A-21B illustrate examples cases in which one or more metrics are evaluated using KPI conditions in accordance with example embodiments of the present disclosure;

FIG. 22 illustrates an example data collection request for AI-aided data collection in accordance with example embodiments of the present disclosure;

FIG. 23 illustrates an example periodicity for AI-aided data collection in accordance with example embodiments of the present disclosure;

FIG. 24 illustrate an example cycle termination request in accordance with example embodiments of the present disclosure;

FIG. 25 illustrates an example data collection termination condition in accordance with example embodiments of the present disclosure;

FIG. 26 illustrates another example data collection termination condition in accordance with example embodiments of the present disclosure;

FIGS. 27A-27C illustrate example data filtering and training set generation techniques in accordance with example embodiments of the present disclosure;

FIGS. 28A-28D illustrate example solutions to misalignment cases of FIG. 27C in accordance with example embodiments of the present disclosure;

FIG. 29 illustrates an exampling training process of the generative adversarial network of FIG. 28D in accordance with example embodiments of the present disclosure; and

FIG. 30 illustrates an example flow chart for an AI-aided data collection method according to embodiments of the present disclosure.

### DETAILED DESCRIPTION

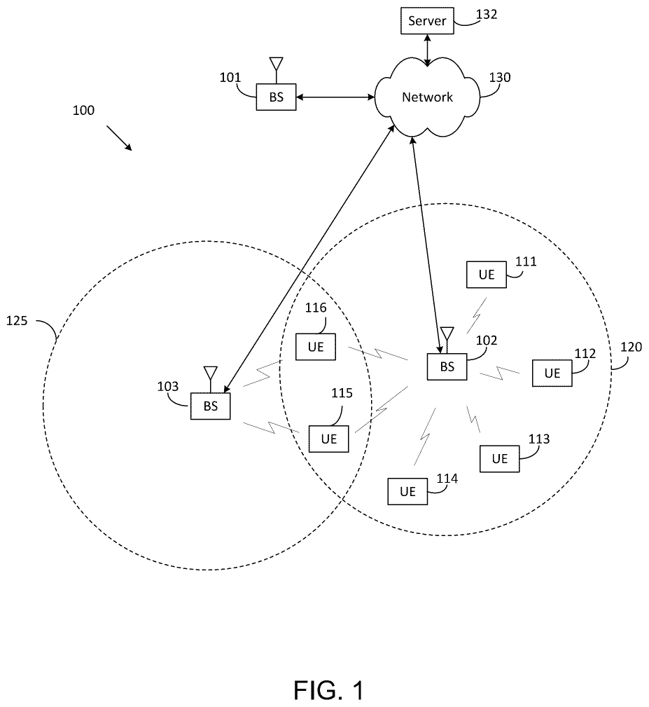

FIGS. 1 through 30, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-5 below describe various embodiments implemented in wireless communications systems and with the use of orthogonal frequency division multiplexing (OFDM) or orthogonal frequency division multiple access (OFDMA) communication techniques. The descriptions of FIGS. 1-5 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB (e.g., base station, BS) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an AI-based cellular system. As such, the at least one network 130 may be operably coupled to a network device (e.g., without limitation, a server) 132 configured to, for example and without limitation, receive data from the gNBs 101-103 via backhaul/network interfaces and train and/or test an AI model to perform channel estimation. The server 132 may represent one or more servers, and each server 132 includes a suitable computing or processing device for training and/or testing the AI model. Each server 132 could, for example, include one or more processing devices, one or more memories storing instructions and data, and one or more network interfaces to receive the data. The AI model can then be trained, tested and deployed to effectively perform channel estimation for reliable and efficient communications in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support the gNB 101-103 for performing wireless communications tasks. In certain embodiments, one or more of the gNBs 101-103 include circuitry, programing, or a combination thereof, to perform wireless communications tasks using the large channel model.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

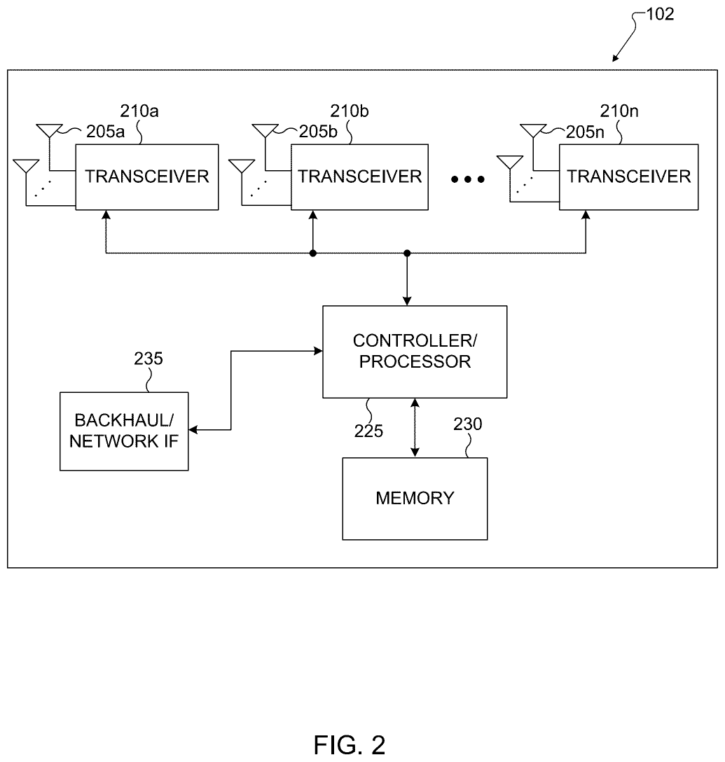

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform AI aided channel estimation as discussed further in detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

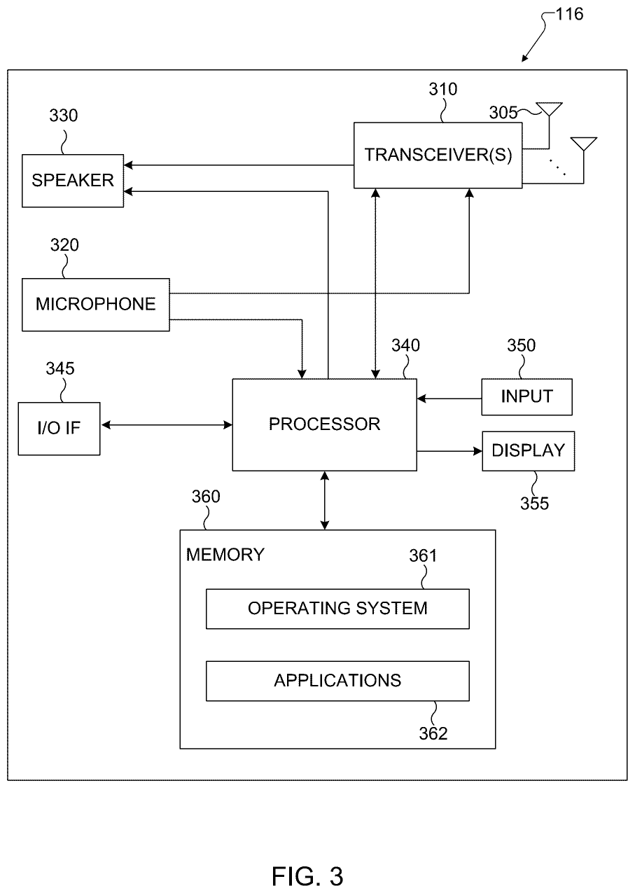

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support the AI-aided channel estimation method as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

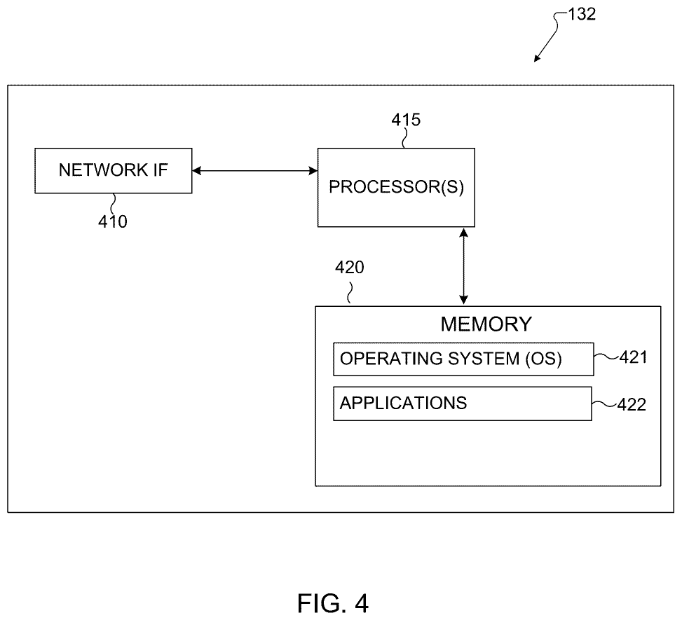

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410, the UEs 111-116 via the gNBs 101-103, or any other appropriate sources. The server 132 may also train and/or test an AI model to perform channel estimation as discussed further in detail below. The server 132 may then.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network such as an AI CE model as well as a CPU, a GPU or a tensor processing unit (TPU) that provides significant computational resources required for training the AI CE model.

The processor 415 is also capable of executing other processes and programs resident in the memory 420, such as operations that receive and store data. As described in greater detail below, the processor 415 may execute processes to train and/or test an AI CE model to perform channel estimation in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for the AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

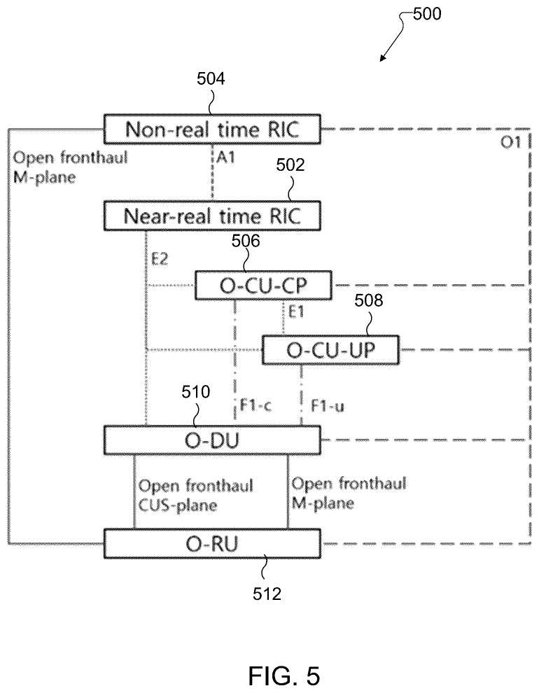

FIG. 5 illustrates an example architecture of an open radio access network (O-RAN) 500 according to embodiments of this disclosure. The O-RAN 500 may be a next generation network beyond 5G and 6G, representing a concerted effort to shift towards more intelligent, open, virtualized and interoperable network systems. The embodiment of the O-RAN 500 shown in FIG. 5 is for illustration only. Other embodiments of the O-RAN 500 could be used without departing from the scope of this disclosure.

As illustrated in FIG. 5, the O-RAN 500 may be a virtualized RAN established on an open hardware and cloud with an embedded AI-powered radio control. It may include a near-real-time RAN Intelligent Controller (near-RT RIC) 502, a non-RT RIC 504, an O-RAN Central Unit Control Plane (O-CU-CP) 506, an O-RAN Central Unit-User Plane (O-CU-UP) 508, an O-RAN Distributed Unit (O-DU) 510, and an O-RAN Radio Unit (O-RU) 512. The near-RT RIC 502 may provide real-time control and optimization of O-RAN elements through data collection and actions over the E2 interface. The non-RT RIC 504 may enable non-real-time control and optimization of RAN elements, AI and/or ML (AI/ML) workflows, and policy-based guidance for near-RT RIC applications. The O-CU-CP 506 and the O-CU-UP 508 may handle the control plane and user plane protocols, respectively. The O-CU-CP 506 may provide a connection to a core network via a backhaul link, and the O-CU-UP 508 may communicate with one or more O-DUs 510 via a midhaul link. The O-DU 510 and the O-RU 512 may play crucial roles in the O-RAN architecture by managing different layers of functionality.

The O-DU 510 may be an electronic device (e.g., a base station 101-103 of FIGS. 1 and 2) and provide network functions such as radio link control (RLC) or medium access control (MAC) functions. It may communicate with one or more O-RUs 512 to provide lower layer network functions, such as lower layer physical (PHY) and/or radio frequency (RF) functions. One or more O-RUs 512 may provide direct RF connection with one or more UEs or other nodes. Thus, in the O-RAN 500 a classical transmit/receive chain for uplink and downlink is split across the O-RUs 512, the O-DUs 510, and the O-CU-CP/UP 506, 508 based on factors such as a need for centralized compute, complexity requirements to the O-RUs 512 that include actual radio frequency (RF) antennas, and consequential requirements on capacity of a fronthaul link and a midhaul link. Multiple O-RUs 512 may be connected to an O-DU 510 and multiple O-DUs 510 may be connected to an O-CU-UP 508.

In this way, the O-RAN 500 may allow interoperability between cellular network equipment provided by different mobile service providers, thereby allowing spectrum sharing by the mobile network providers while differentiating their key performance indicators (KPIs).

Although FIG. 5 illustrates one example architecture of the O-RAN 500, various changes can be made to FIG. 5. For example, various components in FIG. 5 can be combined, further subdivided, or omitted and additional components can be added according to particular needs.

AI and machine learning (ML) techniques have been rapidly gaining traction in the wireless industry and increasingly integrated in the modern wireless communication such as those described regarding FIGS. 1-5, to improve performance across all layers of wireless communication systems, including the physical (PHY) layer. Thus, the advancements of the AI and ML techniques may provide substantial opportunities for optimizing future-generation of the wireless communications systems such as the O-RAN 500.

For example, the AI and ML techniques may optimize the O-RUs 512, enabling them to handle higher data rates with broader coverage in the variable range of the frequency spectrum. By continuously collecting data, the AI and ML techniques can refine their base models and adapt to specific deployment conditions, making the algorithms well-suited for addressing the coverage challenges while maximizing the capacity potential of the O-RUs 512. As a data driven technique, the application and scenario specific data collection may improve the performance of AI/ML modules (hereinafter, also referred to as AI modules).

However, a significant amount of data may be generated from the field every time period, and to handle the significant amount of data, multiple AI/ML modules can be utilized for each entity (e.g., O-RU 512, O-DU 510, etc.). Further, each RIC 502, 504 may be connected to a significant number (e.g., thousands) of such entities. As such, if the blind data collection is performed, a large traffic and storage can be required.

For monitoring and training of the AI modules, a field data down selection may be crucial as this can reduce the traffic and memory demands without losing meaningful (relevant) information. Further, the meaningful data may be hidden in the data collection for the AI/ML module training and/or vary with different training purposes, thereby rendering data pruning crucial for the improved performance of the AI/ML modules. For example, the data pruning can result in avoiding garbage-in garbage-out.

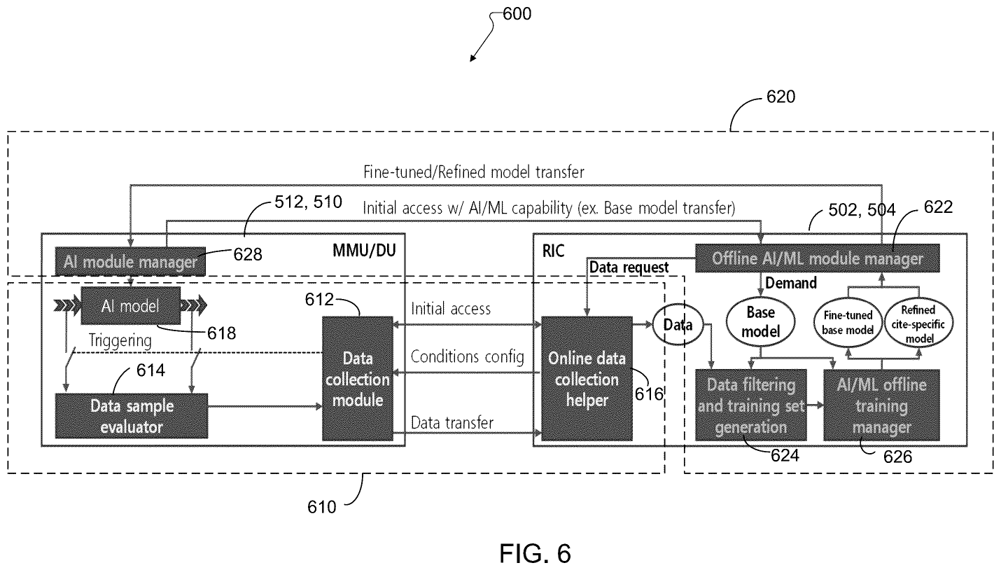

This disclosure provides an AI module life cycle management (LCM) framework. By utilizing a conditional field data collection and an on-demand AI model fine-tuning and retraining, the AI module LCM framework may provide an effective and efficient data collection mechanism as discussed further in detail with reference to FIGS. 6-30.

FIG. 6 illustrates an example architecture 600 of an AI-aided data collection method in wireless communication systems according to embodiments of the present disclosure. Note that the example architecture 600 also illustrates an example framework of the lifecycle management of AI models or modules utilized in the data collection method.

As illustrated in FIG. 6, the example architecture 600 may include a conditional data collection unit 610 and a model training unit 620. The conditional data collection unit 610 may include a data collection module 612, a data sample evaluation module 614, an online data collection assistance module 616, and an AI model 618. The data collection module 612, the data sample evaluation module 614 and the AI model 618 may be included in an O-RU (e.g., a massive multiple-input multiple-output (MIMO) unit (MMU)) 512 or an O-DU 510. An MMU may be a specialized RU that integrates the massive MIMO technology to support a large number of antenna elements, thereby enabling advanced beamforming, spatial multiplexing and improved spectral efficiency. The online data collection assistance module 616 may be included in an upper entity such as an RIC 502, 504.

The data collection module 612 may be communicatively connected to the data sample evaluation module 614, the online data collection assistance module 616, and the AI model 618. The data collection module 612 may be configured to control the field data collection, examine one or more specific data collection conditions, and control a target AI module (here, the AI module 618). The data collection module 612 may receive a data collection demand configured by the online data collection assistance module 616, process the data collection demand, trigger data collection based on the data collection demand, and transfer the collected data to the data sample evaluation module 614. The data collection module 612 may also filter the collected data samples based on the data collection condition. It may then generate data packages and transfer the data packages to the online data collection assistance module 616.

The data sample evaluation module 614 may be communicatively connected to the data collection module 612 and the AI model 618. The data sample evaluation module 614 may perform data evaluation by, e.g., adding tag(s) to each of the collected data samples. The tags may be configured by the online data collection assistance module 606. The tagged data samples may be transmitted to a buffer, e.g., in the data collection module 604.

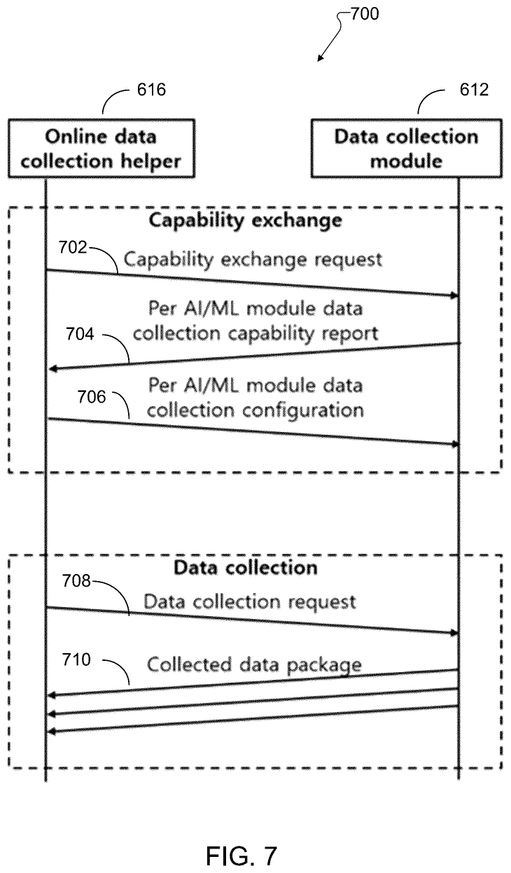

The online data collection assistance module 606 may be communicatively connected to the data collection module 604, generate a data collection demand and configure one or more data collection parameters for the data collection module 604. The data collection parameters can include a data collection condition configuration. The data collection condition configuration may include, for example, a time window and a set of data collection conditions. Each data collection condition may include a condition expression for data samples and a minimum number of data samples to be included in the data packages. FIGS. 7-26 illustrate the conditional data collection unit 610 and operations thereof in further detail.

The model training unit 620 may include an offline AI module manager 622, a training dataset generator 624, an offline model training manager 626, and a target AI module manager 628. The model training unit 620 may perform on-demand model fine-tuning and retraining of target AI models (e.g., the AI model 618). The offline AI module manager 622 may be included in the RIC 502, 504 and control the training dataset generator 624 and the offline model training manager 626 for lifecycle management of the AI modules in the governing area. It may configure a training (fine-tuning and/or retraining) strategy for the target AI models. It may also evaluate the target AI models and generate model update demands.

The training dataset generator 624 may generate a training dataset based on, e.g., model update demands and data processing. It may investigate and process the collected data by removing noise (filtering), redundancy (pruning), domain mismatches (domain alignment), etc. to adjust the training strategy. For example, when the collected data deviates (e.g., the field feature statistics is different from those used for a base AI model), refinement of the training dataset may be needed. Such refinement may include a feature domain alignment, and the domain-aligned training dataset(s) may be transferred to the target AI models by the offline AI module manager 622 on demand. Thus, the training dataset can be customized for specific training purposes.

The offline model training manager 626 may determine hyperparameters for training the target AI models based on the training strategy and the training dataset provided by the training dataset generator 624. The offline model training manager 626 may then train the target AI models using the hyperparameters. In one embodiment, one or more fine-tuned and retrained models (versions) may be transferred through the offline AI module manager 622 and then to the target AI module manager 628. In another embodiment, the offline model training manager 626 may test the one or more fine-tuned and retrained models. If the one or more newly fine-tuned and retrained models are approved, they may be transferred through the offline AI module manager 622 and then to the target AI module manager 628. In yet another embodiment, the one or more fine-tuned and retrained models may replace the existing base model. In yet another embodiment, the one or more fine-tuned and retrain models may be stored in memory with historical models of each AI model.

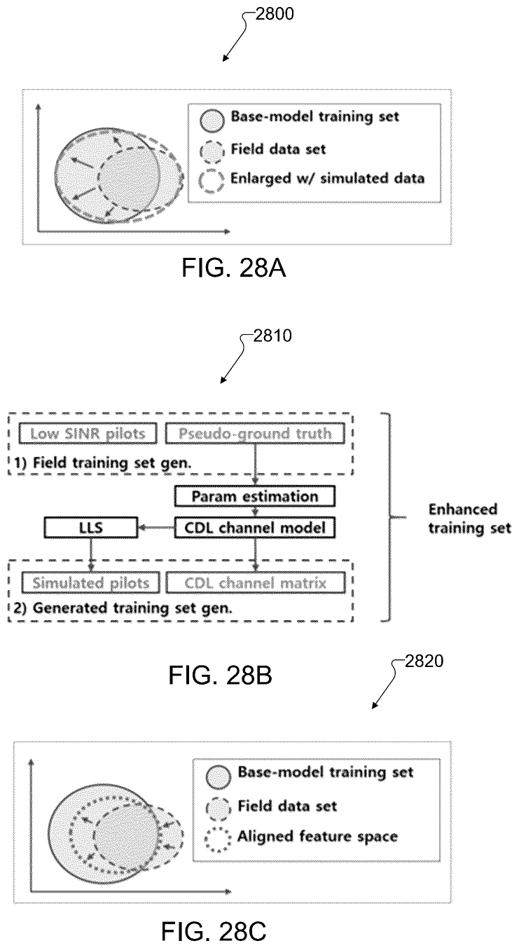

The target AI module manager 628 may be disposed in the O-RU 512 or O-DU 510 and control capability exchange process including module registration, base model transfer, base model training set transfer, base model training hyper parameter transfer, etc. The target AI module manager 628 may also control the application of the weights of the target AI model 618 when a fine-tuned or retrained model is ready. In one embodiment, the target AI module manager 628 may apply the fined-tuned or retrained model upon receipt. In another embodiment, the target AI module manager 628 may apply the fine-tuned or retrained model according to the configured time frame by the offline AI module manager 622. FIGS. 27A-29 illustrate the model training unit 620 and operations thereof in further detail.

Although FIG. 6 illustrates one example architecture 600 of an AI-aided data collection technique, various changes may be made to FIG. 6. For example, various components or functions in FIG. 6 may be combined, further subdivided, replicated, omitted, or rearranged and additional components or functions may be added according to particular needs.

FIG. 7 illustrates an example signaling process 700 for the AI-aided data collection method in accordance with example embodiments of the present disclosure. The example signaling process 700 may be performed between the components of the conditional data collection unit 610 of FIG. 6. The example signaling process 700 shown in FIG. 7 is for illustration only. Other signaling processes could be used by the components of the conditional data collection unit 610 without departing from the scope of this disclosure.

The online data collection assistance module 616, for example, may exist inside a RIC 502, 504, and configure the data collection module 612 that may, for example, exist inside the O-DU 510 and/or the O-RU 512 through the O1 interface. For example, for the O-RU 512, the configuration signaling can be transferred through the open-fronthaul M-plane.

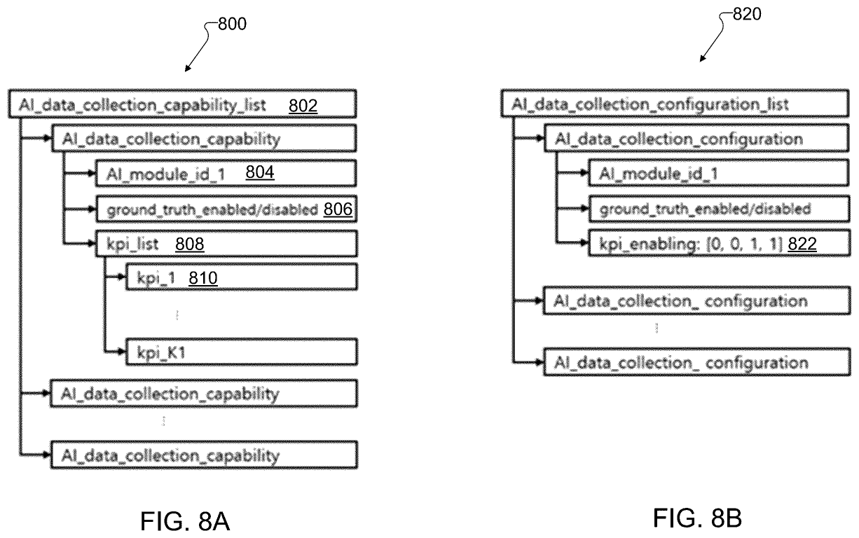

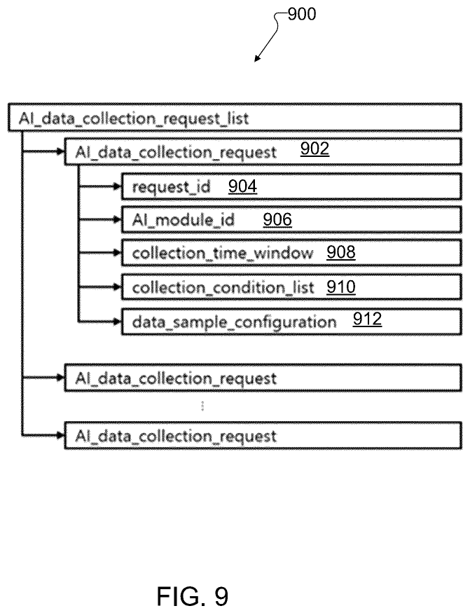

In the example signaling process 700 as illustrated in FIG. 7, the signaling process 700 may include a capability exchange signaling and a data collection signaling. The capability exchange signaling may be utilized to initiate the capability exchange for the AI module data collection. The capability exchange may include three steps 702-706. At step 702, the online data collection assistance module 616 may transmit a capability exchange request to the data collection module 612 for data collection through the open fronthaul M-plane or the O1 interface. At step 704, the data collection module 612 may respond to the online data collection assistant module 616 through a data collection capability report. An example data collection capability report is illustrated in FIG. 8A. At step 706, the online data collection assistance module 616 may transfer per AI module data collection configuration.

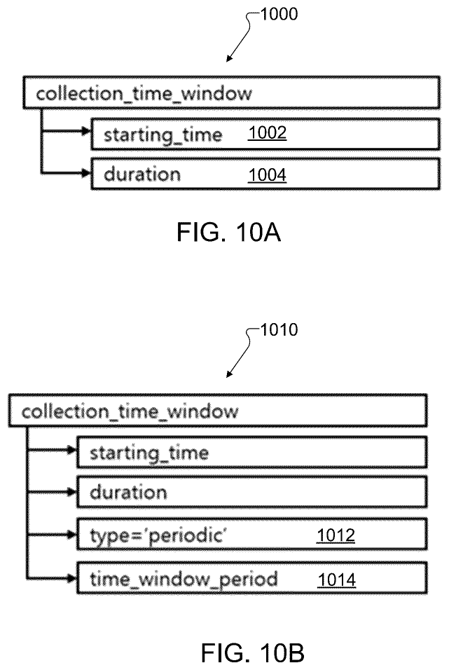

Upon completion of the capability exchange, the data collection may be performed in two steps 708 and 710. At step 708, the online data collection assistance module 616 may transfer one or more data collection requests to the data collection module 612 as shown in FIG. 7. The one or more data collection requests may be transferred through the open fronthaul M-plane or the O1 interface. An example data collection request is illustrated in FIG. 9.

Based on the data collection request, the data collection module 612 may collect data samples. Each of the collected data samples may be evaluated by the data sample evaluation module 614 using all of data collection conditions included in the data collection request. Each data collection condition may be evaluated and, if the data collection condition is satisfied, a tag may be attached to the data sample, e.g., by the index 1202 of the data collection condition. The data sample with no tag after the evaluation may be discarded. During the data collection, if some of the data collection conditions have been satisfied, new collected data samples that only satisfy the already satisfied data collection condition(s) may not be discarded. The data collection may be terminated when all of the data collection conditions are satisfied.

At step 710, when the data collection is terminated, the data collection module 612 may pack the selected (collected) data samples into a package and transfer the package to the online data collection assistance module 616. In an example, the packages may be transferred through the open fronthaul M-plane. In another example, the packages may be transferred through the O1 interface.

FIG. 8A illustrates an example AI data collection capability report 800 in accordance with example embodiments of the present disclosure. The example AI data collection capability report 800 shown in FIG. 8A is for illustration only. Other AI data collection capability reports could be used without departing from the scope of this disclosure.

As shown in FIG. 8A, the AI data collection capability report 800 may include a list 802 of associated AI modules 804 that support the conditional data collection. Optionally, it may report supporting capability of ground truth or pseudo ground truth collection 806. It may also report a list 808 of key performance indicators (KPIs), what can be evaluated for each of the associated AI modules. Alternatively, the KPIs may be specified in a relevant standard specification, and the specified KPIs 810 may be included in the capability report 800. For each AI data collection capability report 800 received from the data collection module 612, the online data collection assistance module 616 may transmit a data collection configuration message to the data collection module 612. An example data collection configuration message is illustrated in FIG. 8B.

FIG. 8B illustrates an example data collection configuration message 820 in accordance with example embodiments of the present disclosure. The example data collection configuration message 820 shown in FIG. 8B is for illustration only. Other data collection configuration message could be used without departing from the scope of this disclosure.

In response to the AI data collection capability report 800 received from the data collection module 612, the online data collection assistance module 616 may transmit a data collection configuration message 820 to the data collection module 612 in order to control the enabling or disabling of each reported KPI 810 and other features.

As shown in FIG. 8B, the data collection configuration message 820 may include a Boolean list 822 indicating the enabling or disabling of the specified KPIs per each of the associated AI models.

FIG. 9 illustrates an example data collection request 900 in accordance with example embodiments of the present disclosure. The example data collection request 900 shown in FIG. 9 is for illustration only. Other data collection requests could be used without departing from the scope of this disclosure.

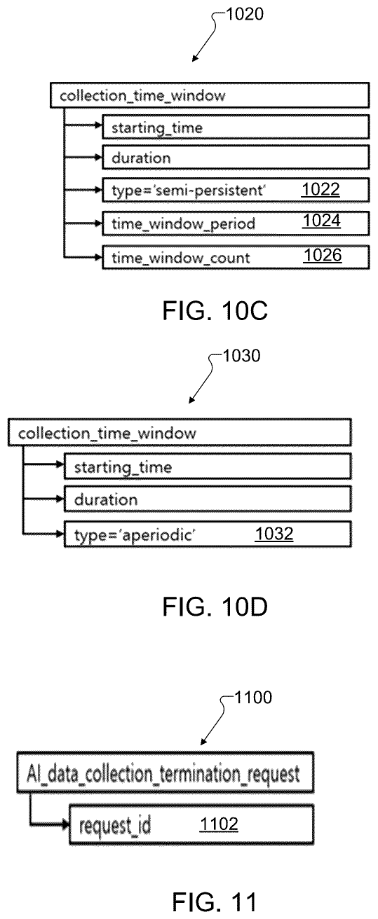

As illustrated in FIG. 9, each 902 of the one or more data collection requests 900 may include a request_id 904 that may distinguish the request and be used in a data collection report from the data collection module 612 to the online data collection assistance module 616. Each request 902 may also include an AI_module_id used to identify the AI_module 804 reported during the capability exchange. It may further include a collection time window configuration 908 indicating the time at which the data collection is to occur. Example collection time window configurations are illustrated in FIGS. 10A-10D.

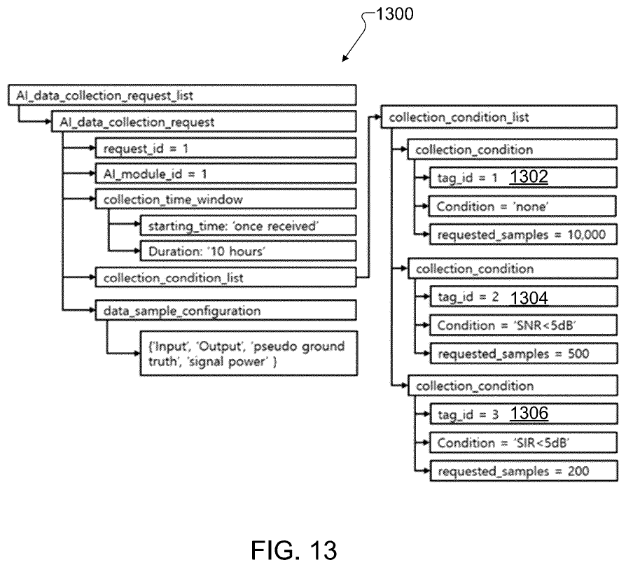

Each request 902 may also include a collection condition list configuration (e.g., collection_condition_list) 910 indicating the contents of the requested data, i.e., a data sample filter enabling on demand data collection. An example collection condition list configuration is illustrated in FIG. 12.

Each request 902 may additionally include a data sample configuration 912 that indicates the information to be included per data sample. The online data collection assistance module 616 may configure the components of the collected data samples besides tags. For example, the online data collection assistance module 616 may configure one or more components of each of the collected data samples from a below example list:
AI module input data
AI module output data
(pseudo) ground truth data
Measurement: KPI with index and measured values, e.g., SNR, interference plus noise power (IpN), timing advance, frequency offset, etc.
Scheduling information: contextual information related to the collected data sample, e.g., timing information, such as frame index, slot index, time stamp, etc.; and a number of configured MIMO users, MCS, etc.

FIGS. 10A-10D illustrate example collection time window configurations 1000, 1010, 1020 and 1030 in accordance with example embodiments of the present disclosure. The example collection time window configurations 1000, 1010, 1020 and 1030 shown in FIGS. 10A-10D may be the same or similar collection time window configurations as the collection time window configuration 908 of FIG. 9. The example collection time window configurations 1000, 1010, 1020 and 1030 are for illustration only. Other collection time window configurations could be used without departing from the scope of this disclosure.

A collection time window configuration may configure the start and the end of the data collection. If, during the time window, the requested data samples configured by the collection condition list 910 are sufficient, the data collection may be terminated. If the timing window is ended, the data collection may be terminated even if the collection condition list 910 has not been accomplished.

In an alternative, only the duration may be specified without the starting time, which indicates the data collection module 612 may start data collection once the data collection request is received from the online data collection assistance module 616.

In another alternative, each data collection request may include a single time window. For example, as illustrated in FIG. 10A, the collection time window configuration 1000 may include a starting time 1002 and a duration 1004.

In another alternative, each data collection request 902 can contain one or multiple periodic time windows. For example, the periodicity type may be periodic, semi-persistent, and aperiodic.

The collection time window configuration may configure one or more periodic collection time windows such that the one or more collection time windows may repeat in a configured period. For example, as illustrated in FIG. 10B, an example periodic collection time window configuration 1010 may include a configured periodicity type 1012 indicated as ‘periodic’ and the collection period configured in a time_window_period 1014.

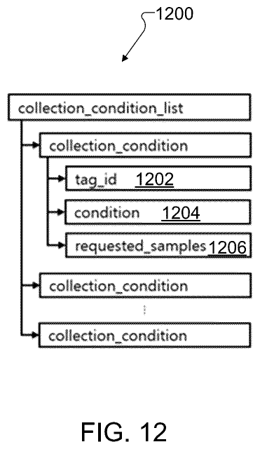

The data collection may be terminated by an explicit data collection termination request as illustrated in FIG. 11.

A semi-persistent data collection time window configuration may configure one or more collection time windows to repeat in a configured period with a finite number of collections. As illustrated in FIG. 10C, an example semi-persistent data collection time window configuration 1020 may include a configured periodicity type 1022 indicated as ‘semi-persistent’. It may also include the collection period configured in time_window_period 1024. It may further include a number of collection window configured in a time_window_count 1026.

The data collection time window configuration may configure data collection to occur in an aperiodic manner as illustrated in FIG. 10D. For example, an example aperiodic data collection time window configuration 1030 may configure only one collection time window and indicate the periodicity type 1032 of the collection time window as ‘aperiodic’.

FIG. 11 illustrates an example data collection termination request 1100 in accordance with example embodiments of the present disclosure. The example data collection termination request 1100 shown in FIG. 11 is for illustration only. Other data collection termination requests could be used without departing from the scope of this disclosure.

As shown in FIG. 11, the data collection can be terminated by an explicit data collection termination request 1100. For example, a request_id 1102 may be included in the data collection termination request 1100. Upon receipt of the termination request 1100, the data collection module 612 may terminate the data collection request 904 with the same request_id.

FIG. 12 illustrates an example collection condition list configuration 1200 in accordance with example embodiments of the present disclosure. The example collection condition list configuration 1200 is the same or similar to the collection condition list configuration 910 included in the data collection request 900 of FIG. 9. The example data collection list configuration 1200 shown in FIG. 12 is for illustration only. Other collection condition list configurations could be used without departing from the scope of this disclosure.

As illustrated in FIG. 12, a list of data collection conditions may be configured in an example collection condition list configuration 1200. Each data collection condition may include:
An index (e.g., tag_id) 1202 of the data collection condition.
A condition 1204, e.g., an expression of KPI that has been reported as capable of the targeted AI module (e.g., with the same name or index in the capability report 800). For each data sample satisfied with the condition, the tag_id may be tagged to the data sample. The condition can be absent or ‘none’ or ‘null’. Such condition may indicate a minimum number of samples requested as the value of requested_samples 1206.
A minimum number of samples 1206 requested.

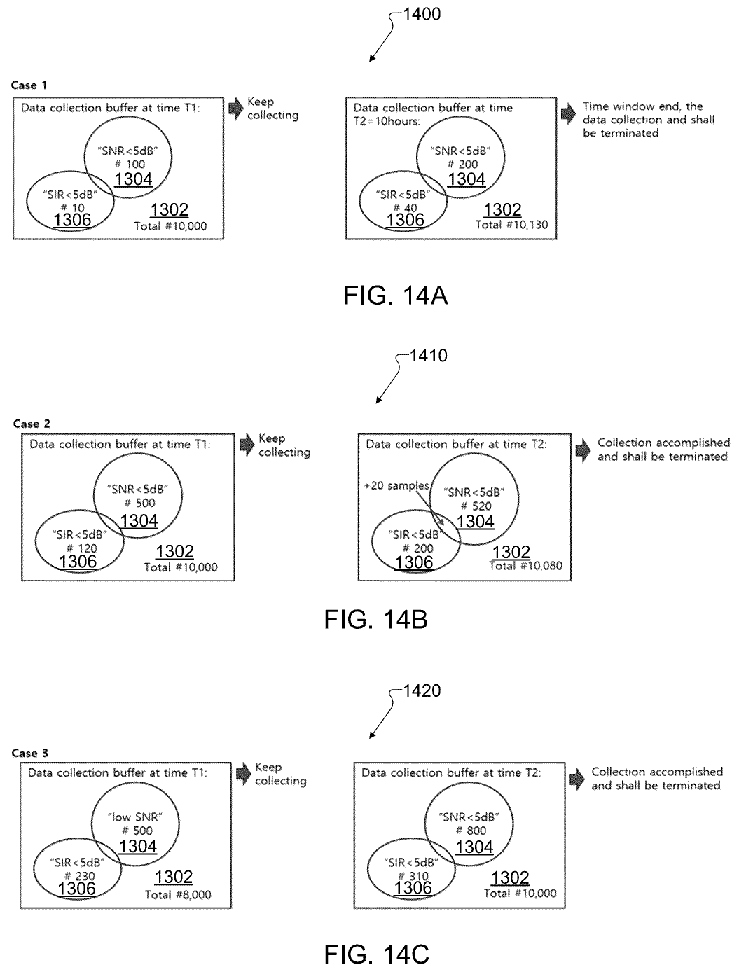

FIG. 13 illustrates an example data collection request 1300 in accordance with example embodiments of the present disclosure. The example data collection request 1300 may be the same or similar to the data collection request 900 of FIG. 9, but described in specific detail. The example data collection request 1300 shown in FIG. 13 is for illustration only. Other data collection requests could be used without departing from the scope of this disclosure.

The online data collection assistance module 616 may transmit a data collection request 1300 to the data collection module 612. In the example data collection request 1300 as illustrated in FIG. 13, the request ID is 1, and the request is directed to an AI model with an identification (ID) 1. In the request 1300, the data collection windows are configured to start at a timing upon which the request 1300 is received (‘once received’) and the data collection is ready. The duration of the data collection is 10 hours, and the requested data samples are restricted by three collection conditions with tag ID 1, 2, 3.
For collection condition with tag ID 1 1302, the collection condition is set as ‘none’, indicating the minimum number of the collected data samples is 10,000.
For collection condition with tag ID 2 1304, the collection condition is set as ‘low SNR’, e.g., a configuration expression related to KPI SNR. The minimum number of the collected data samples is 500.
For collection condition with tag ID 3 1306, the collection condition is set as ‘low SIR’, e.g., a configuration expression related to KPI SIR. The minimum number of the collected data samples is 200.

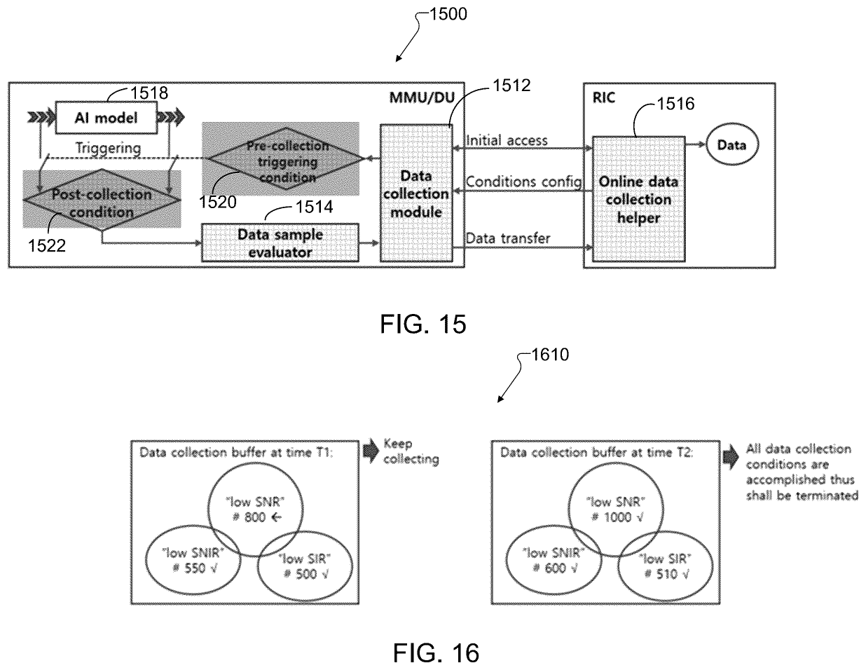

Each data sample contains the input and output of the AI module, the pseudo ground truth, the measured signal power, and all of the tags, if satisfied. Once the data collection is terminated, the collected data sample is packed and transferred to the online data collection assistance module 616 through the M-plane. Example data collection scenarios using the above collection conditions are illustrated in FIGS. 14A-14C.

FIGS. 14A-14C illustrate example data collection scenarios 1400, 1410 and 1420 in accordance with example embodiments of the present disclosure. The example data collection scenarios 1400, 1410 and 1420 shown in FIGS. 14A-14C are for illustration only. Other data collection scenarios may take place without departing from the scope of this disclosure.

In the example scenario 1400 as illustrated in FIG. 14A,
At time T1<10 hours, collection condition with tag ID 1 1302 is satisfied (the number of the collected data samples=10,000), both collection condition with tag ID 2 and tag ID 3 are not satisfied. The data collection is to continue.
At time T2=10 hours, collection condition with tag ID 1 is satisfied, both collection condition with tag ID 2 and tag ID 3 are not satisfied. The data collection is to continue. Due to the ending of time window, the data collection is terminated.

Note that in the example scenario 1400, when collection condition with tag ID 1 1302 is satisfied, such condition is stopped to be evaluated. The new collected data samples are only tagged with tag ID 2 1304 and/or tag ID 3 1306. Therefore, since the total increment of the collected data samples with tag ID 2 1304 and/or tag ID 3 1306 is 130, the total number of the collected data samples increases by 130.

In the example scenario 1410 as illustrated in FIG. 14B,
At time T1<10 hours, collection conditions with both tag ID 1 1302 and tag ID 2 1304 are satisfied, collection condition with tag ID 3 1306 is not satisfied. The data collection is to continue.
At time T2<10 hours, all of the collection conditions with tag ID 1 1302, tag ID 2 1304, and tag ID 3 1306 are satisfied. Due to the accomplishment of all of the data collection conditions, the data collection is terminated at time T2.

Note that in the example scenario 1410, when collection condition with tag ID 1 1302 and tag ID 2 1304 are satisfied, both conditions are stopped to be evaluated. The new collected data samples are only tagged with tag ID 1 1302 and tag ID 2 1304. Therefore, since the total increment of the collected data samples with tag ID 3 1306 is 130, the total number of the collected data samples increases by 80 and the number of the collected data samples with tag ID 2 1304 increases by 20. No data samples without tag ID 2 is to be collected from time T1 to T2.

In the example scenario 1420 as illustrated in FIG. 14C,
At time T1<10 hours, collection conditions with both tag ID 2 1304 and tag ID 3 1306 are satisfied, collection condition with tag ID 1 1302 is not satisfied. The data collection is to continue.
At time T2<10 hours, all of the collection conditions with tag ID 1 1302, tag ID 2 1304, and tag ID 3 1306 are satisfied. Due to the accomplishment of all of the data collection conditions, the data collection is terminated at time T2.

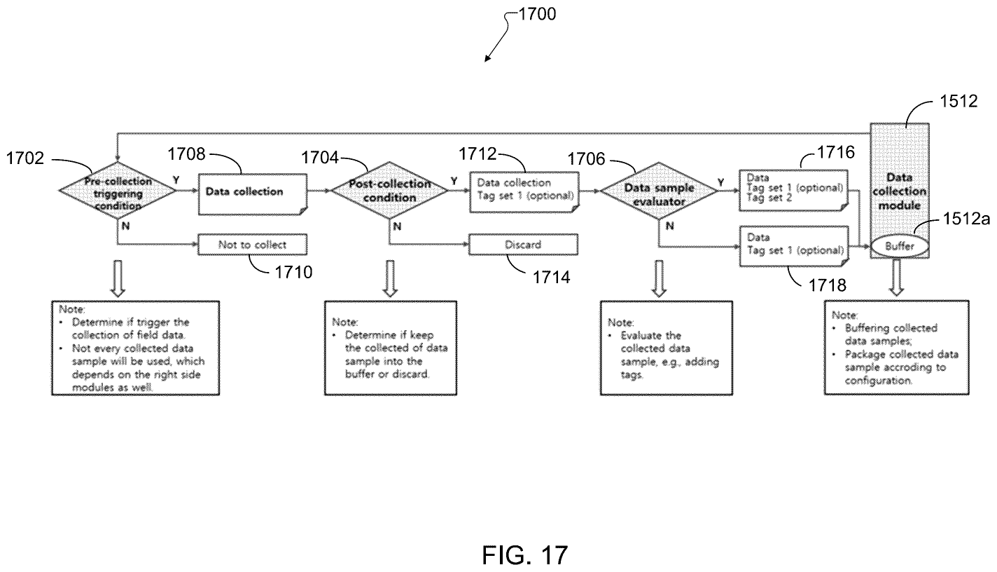

FIG. 15 illustrates an example conditional data collection unit 1500 of an AI-aided data collection architecture in accordance with example embodiments of the present disclosure. The example conditional data collection unit 1500 differs from the conditional data collection unit 610 of FIG. 6 in that it utilizes different types of collection conditions that may be precisely configured. The example conditional data collection unit 1500 shown in FIG. 15 is for illustration only. Other conditional data collection unit with different configurations could be used without departing from the scope of this disclosure.

The example conditional data collection unit 1500 as shown in FIG. 15 may include a data collection module 1512, a data sample evaluation module 1514, an online data collection assistance module 1516, a pre-collection triggering condition evaluation module 1520, a post-collection condition evaluation module 1522, and a target AI model 1518. Similar to the online data collection assistance module 616 of FIG. 6, the online data collection assistance module 1516 may be communicatively connected to the data collection module 1512, generate a data collection demand (a data collection request), configure one or more data collection parameters (e.g., the data collection condition configuration) for the data collection module 1512, and transmit the data collection condition configuration to the data collection module 1512.

The data collection module 1512 may receive and process the data collection demand. The data collection condition configuration may be transferred to the pre-collection triggering condition evaluation module 1520. After receiving an indication from the condition evaluators 1520, 1522 and/or 1514 that a certain field data is to be collected, the data collection module 1512 may capture (collect) the required data in a buffer inside the data collection module 1512 and package the captured data in a required format according to the data collection configuration transmitted from the online data collection assistance module 1516. The data collection module 1512 may deliver the data package(s) and transfer to the online data collection assistance module 1516. In one alternative, the data packages may be transferred to the online data collection assistance module 1516 once the data samples are received. In another alternative, the data samples may be packaged, and the data package may be transferred to the online data collection assistance module 1516 when the buffer reaches a certain condition, for example, the buffer is full. In another alternative, the data samples may be selectively packed according to the configured data collection order.

The pre-collection triggering condition evaluation module 1520 may be communicatively connected to the data collection module 1512 and receive the data collection condition configuration from the data collection module 1512 and monitor the data collection conditions configured by the online data collection assistance module 1516. Such data collection conditions may be evaluated prior to the data collection. For example, the data collection request from the online data collection assistance module 1516 may request the data collection module 1512 to collect an AI-based equalization input during busy (high-traffic) time periods. In another example, the data collection request from the online data collection assistance module 1516 may request the data collection module 1512 to collect AI-based channel estimation input and output after cell switching for, e.g., ten frames. If the data collection condition is satisfied, the pre-collection triggering condition evaluation module 1520 may indicate the field data and KPI collector through, e.g., a triggering signal.

The post-collection condition evaluation module 1522 may be communicatively connected to the data sample evaluation module 1514 and monitor the data collection condition that is configured by the online data collection assistance module 1516 and can only be evaluated after the data collection. For example, the data collection request may be to collect AI-based equalization input and output when the block error rate is higher than 1%. In another example, the data collection request may be to collect AI-based channel estimation input and output when delay spread of the estimated channel is larger than 500 ns. If the data collection condition is satisfied, the condition evaluator indicates the field data and KPI collector through, for example, a triggering signal.

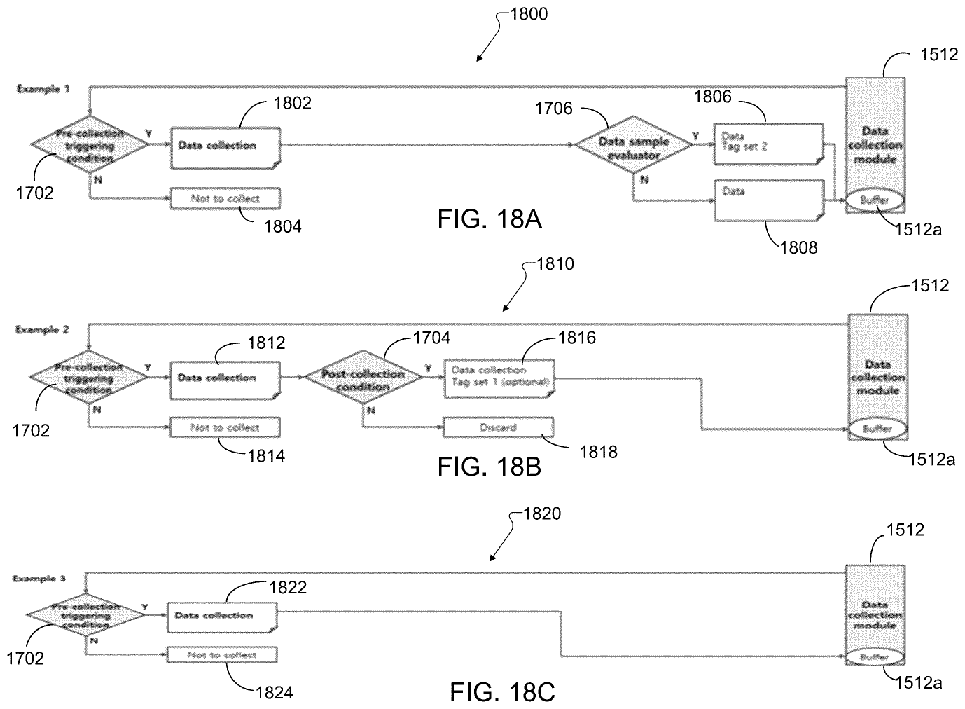

The data sample evaluation module 1514 may be optional in this example conditional data collection unit 1500. For data samples that have been determined to be collected, a data evaluation may be performed to add a tag to the collected data samples. The tag may be pre-defined and configured by the online data collection assistance module 1516. Different from the packing measurement with the collected data samples, the tag may be coarse and only include a tag ID with no specific KPI values. The collected data samples with tags may be transferred into a buffer inside the data collection module 1512. Example data collection request and data collection scenario using this conditional data collection unit 1500 are illustrated in FIGS. 16A and 16B.

FIG. 16 illustrates an example data collection scenario 1600 using the conditional data collection unit 1500 of FIG. 15 in accordance with example embodiments of the present disclosure. The example data collection scenario 1600 shown in FIG. 16 is for illustration only. Other data collection scenarios may occur using the same or different data collection conditions without departing from the scope of this disclosure.

In the example scenario 1600, the online data collection assistance module 1516 may request a data package with 1000 “low SNR” samples, 500 “high SIR” samples, and 500 “low SIR” samples. The “low SNR”, “high SIR”, and “low SIR” may be configured to be evaluated and tagged in the evaluation modules 1520, 1522 and/or 1514 for example.

At time T1 (e.g., <10 hours), the “high SIR” collection condition and the “low SIR” collection conditions are satisfied and thus tagged. Data collection continues since the “low SNR” collection condition has not been met. At time T2 (e.g., ≤10 hours), the “low SNR” collection condition is also satisfied, and thus tagged. Once the data collection module 1512's buffer includes a data package with 1000 collected data samples with the “low SNR” tag, and 500 samples with the “high SIR” tag, and 500 samples with the “low SIR” tag in total, the data collection request may be accomplished and the data package can be transferred to the online data collection assistance module 1516.

The online data collection assistance module 1516 may receive one or more data packages. It may then bundle the data packages and store the collected data samples in memory.

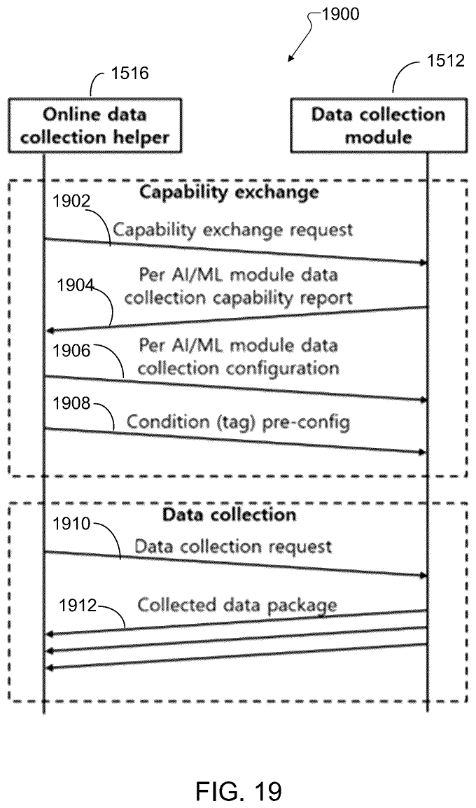

FIG. 17 illustrates an example flow diagram of AI-aided data collection using data collection condition evaluation modules 1702, 1704 and 1706 in accordance with example embodiments of the present disclosure. The data collection condition evaluation modules may include a pre-collection triggering condition evaluation module 1702, a post-collection triggering condition evaluation module 1704, and a data sample evaluation module 1706, which may be the same or similar to the pre-collection triggering condition evaluation module 1520, the post-collection condition evaluation module 1522, and the data sample evaluation module 1514, respectively, as shown in FIG. 15. The evaluation modules 1702, 1704 and 1706 are for illustration only. Other evaluation modules may be used without departing from the scope of this disclosure.

Each of the pre-collection triggering condition evaluation module 1702, the post-collection triggering condition evaluation module 1704, and the data sample evaluation module 1706 may trigger and process each of collected data samples in a row. The collection condition evaluated in each of the evaluation modules 1702, 1704 and 1706 may be configured by the online data collection assistance module 1516. The collected and retained data samples may be transmitted to the buffer in the data collection module 1512 for packaging and transferring to the online data collection assistance module 1516. The contents inside a data package may be configured by the online data collection assistance module 1516.

As illustrated in FIG. 17, the data collection module 1512 may first transmit, to the pre-collection triggering condition evaluation module 1702, one or more collection conditions received from the online data collection assistance module 1516. The pre-collection triggering condition evaluation module 1702 may then determine whether the one or more collection conditions are met before data collection. If the one or more collection conditions are met, the pre-collection triggering condition evaluation module 1702 may trigger the data collection module 1512 to perform data collection (e.g., the field data samples) 1708. If the one or more collection conditions are not met, the pre-collection triggering condition evaluation module 1702 may transmit an indication 1710 to the data collection module 1512 not to collect the field data samples.

Upon collection of the data samples, the post-collection condition evaluation module 1704 may determine if the collected data samples satisfy collection conditions that can be satisfied only after the data collection. If the collected data samples satisfy such collection conditions, the post-collection condition evaluation module 1704 may optionally add one or more tags 1712 indicating that the collection conditions have been satisfied. If the collected data samples do not satisfy such collection conditions, the post-collection condition evaluation module 1704 may discard 1714 the collected data samples that do not satisfy such collection conditions.

Alternatively or in addition, the data sample evaluation module 1706 may evaluate the collected data samples (either from the pre-collection triggering condition evaluation module 1702 or the post-collection condition evaluation module 1704) and determine if one or more collection conditions have been satisfied. If one or more collection conditions have been satisfied, the data sample evaluation module 1706 may optionally add one or more tags 1716 indicating that the one or more collection conditions have been satisfied. If the one or more collected data samples have not been satisfied, the data sample evaluation module 1706 may add tags 1718 to the collected data samples that satisfy one of the one or more collection conditions. The tagged data samples may be transmitted to the buffer 1512a of the data collection module 1512 to generate a data package to be delivered to the online data collection assistance module 1516.

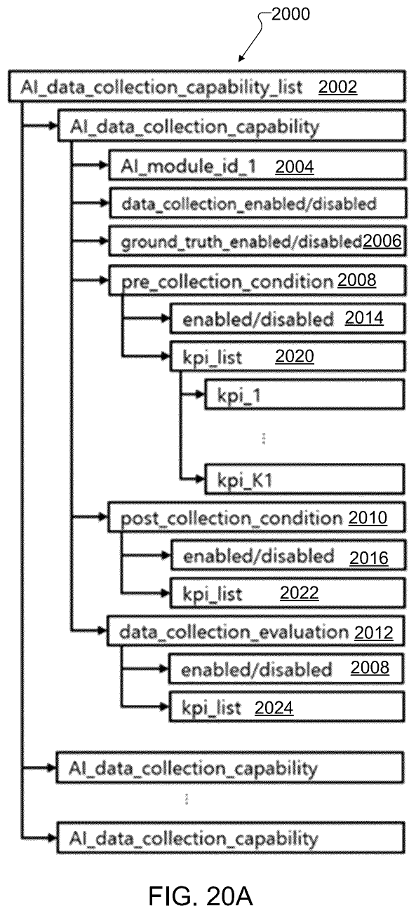

While the pre-collection triggering condition evaluation module 1702 may be expected to exist in order to trigger the data collection, not both of the post-collection triggering condition evaluation module 1704 and the data sample evaluation module 1706 may be provided for each of associated AI modules. Further, not both of the post-collection triggering condition evaluation module 1704 and the data sample evaluation module 1706 may be configured by the online data collection assistance module 1516 in each data collection request. Example scenarios in which all or some of the evaluation modules can be configured are illustrated in FIGS. 18A-18C. The pre-collection condition evaluator is expected to exist, in order to trigger the data collection.

FIGS. 18A-18C illustrate example scenarios 1800, 1810 and 1820 in which all or some of the evaluation modules 1702, 1704, 1706 are configured in accordance with example embodiments of the present disclosure. The example scenarios 1800, 1810 and 1820 are for illustration only. Other scenarios using different evaluations modules and/or collection conditions may occur without departing from the scope of this disclosure.

In the example scenario as illustrated in FIG. 18A, the pre-collection triggering condition evaluation module 1702 may receive one or more collection conditions from the data collection module 1512 and determine whether one or more collection conditions are met before data collection. If the one or more collection conditions are met, the pre-collection triggering condition evaluation module 1702 may trigger the data collection module 1512 to perform data collection (e.g., the field data samples) 1802. If the one or more collection conditions are not met, the pre-collection triggering condition evaluation module 1702 may transmit an indication 1804 to the data collection module 1512 not to collect the field data samples.

Upon collection of the data samples, the data sample evaluation module 1706 may evaluate the collected data samples and determine if one or more collection conditions have been satisfied. If one or more collection conditions have been satisfied, the data sample evaluation module 1706 may optionally add one or more tags 1806 indicating that the one or more collection conditions have been satisfied and the tagged data samples may be stored in the buffer 1512a. If the one or more collected data samples have not been satisfied, the collected data samples may be stored in the buffer 1512a.

In the example scenario 1810 as illustrated in FIG. 18B, the pre-collection triggering condition evaluation module 1702 may receive one or more data collection conditions from the data collection module 1512 and determine whether one or more collection conditions are met before data collection. If the one or more collection conditions are met, the pre-collection triggering condition evaluation module 1702 may trigger the data collection module 1512 to perform data collection (e.g., the field data samples) 1812. If the one or more collection conditions are not met, the pre-collection triggering condition evaluation module 1702 may transmit an indication 1814 to the data collection module 1512 not to collect the field data samples.

Upon data collection, the post-collection condition evaluation module 1704 may determine if the collected data samples satisfy collection conditions that can be satisfied only after the data collection. If the collected data samples satisfy such collection conditions, the post-collection condition evaluation module 1704 may optionally add one or more tags 1816 indicating that such collection conditions have been satisfied. If the collected data samples do not satisfy such collection conditions, the post-collection condition evaluation module 1704 may discard 1818 the collected data samples that do not satisfy such collection conditions. The tagged data samples may be stored in the buffer 1512a.

In the example scenario 1820 as illustrated in FIG. 18C, the or in addition, the pre-collection triggering condition evaluation module 1702 may receive one or more data collection conditions from the data collection module 1512 and determine whether one or more collection conditions are met before data collection. If the one or more collection conditions are met, the pre-collection triggering condition evaluation module 1702 may trigger the data collection module 1512 to perform data collection 1822. The collected data samples may be stored in the buffer 1512a. If the one or more collection conditions are not met, the pre-collection triggering condition evaluation module 1702 may transmit an indication 1824 to the data collection module 1512 not to collect the field data samples.

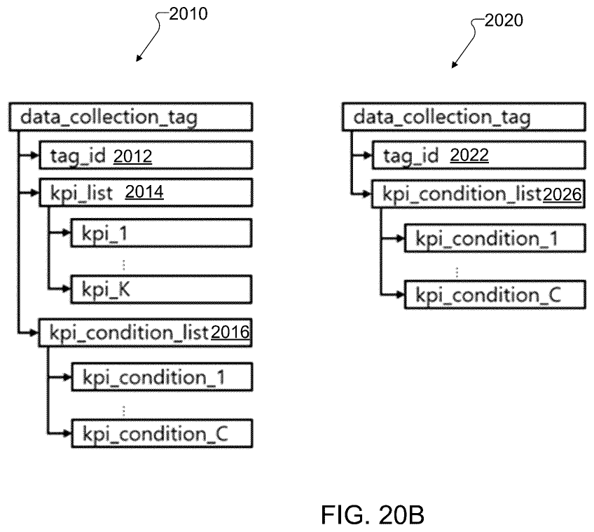

FIG. 19 illustrates an example signaling process 1900 using the conditional data collection unit 1500 of FIG. 15 in accordance with example embodiments of the present disclosure. The example signaling process 1900 may be performed between the components of the conditional data collection unit 1500 of FIG. 15. The example signaling process 1900 shown in FIG. 19 is for illustration only. Other signaling processes could be used by the components of the conditional data collection unit 1500 without departing from the scope of this disclosure.

The online data collection assistance module 1516, for example, may exist inside a RIC 502, 504, and configure the data collection module 1512 that may, for example, exist inside the O-DU 510 and/or the O-RU 512 through the O1 interface. For example, for the O-RU 512, the configuration signaling can be transferred through the open-fronthaul M-plane.

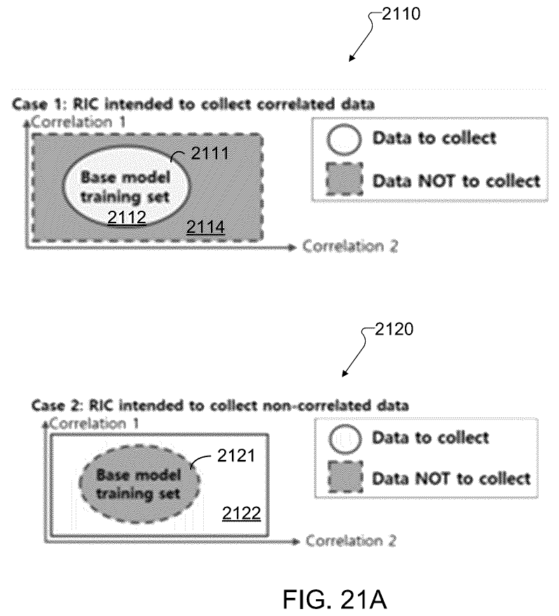

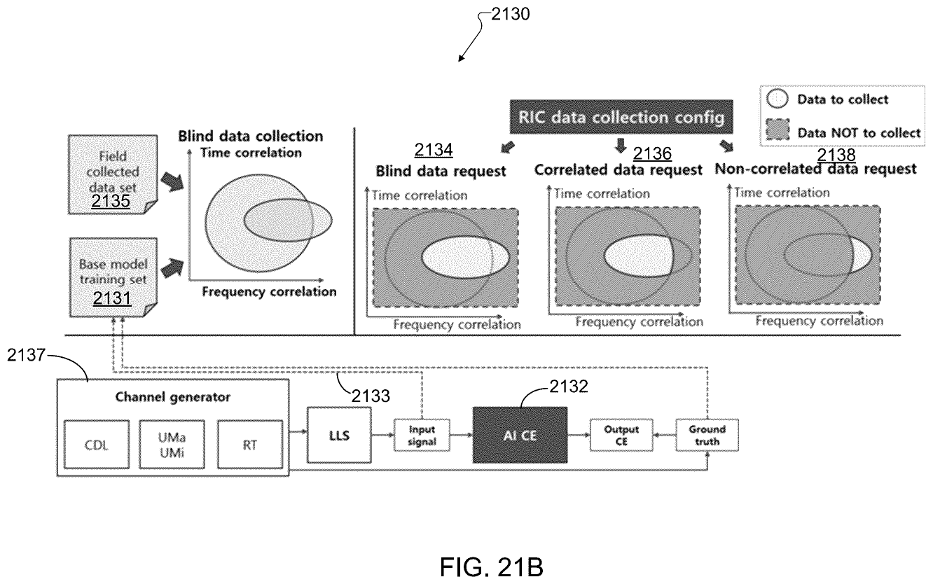

As illustrated in FIG. 19, the capability exchange for the AI module data collection may be performed. The capability exchange may include four steps 1902, 1904, 1906 and 1908. At step 1902, the online data collection assistance module 1516 may transmit a capability exchange request to the data collection module 1512 for data collection through the open fronthaul M-plane or the O1 interface. At step 1904, the data collection module 1512 may respond to the online data collection assistant module 1516 through a data collection capability report. An example data collection capability report is illustrated in FIG. 20A. At step 1906, the online data collection assistance module 1516 may transfer per AI module data collection configuration. For example, the supported data collection condition evaluation module can be disabled., and the KPI in each kpi_list can be down-selected. At step 1908, the online data collection assistance module 1516 may configure tags as data collection conditions. An example tag is illustrated in FIG. 20B.

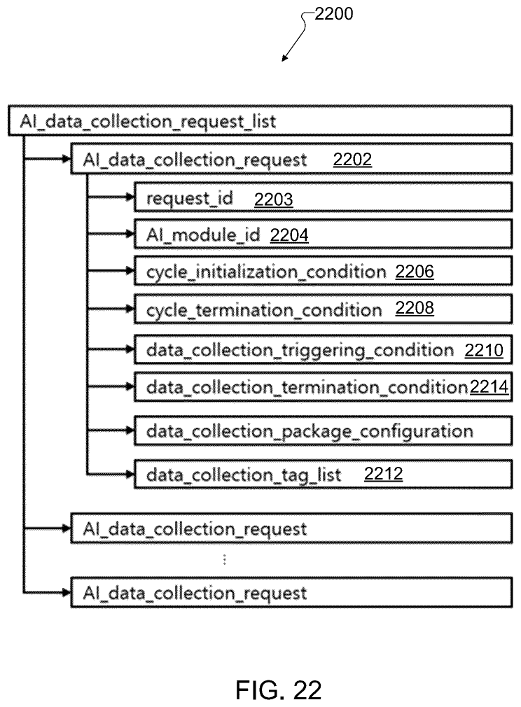

Upon completion of the capability exchange, data collection may be performed in two steps 1910 and 1912. At step 1910, the online data collection assistance module 1516 may transfer one or more data collection requests to the data collection module 1512 as shown in FIG. 15. The one or more data collection requests may be transferred through the open fronthaul M-plane or the O1 interface. An example data collection request is illustrated in FIG. 21.

Based on the data collection request, the data collection module 1512 may collect data samples. Each of the collected data samples may be evaluated by the data sample evaluation module 1512 using all of data collection conditions included in the data collection request. Each data collection condition may be evaluated and, if the data collection condition is satisfied, a tag may be attached to the data sample, e.g., by the index 1914 of the data collection condition. The data sample with no tag after the evaluation may be discarded. During the data collection, if some of the data collection conditions have been satisfied, new collected data samples that only satisfy the already satisfied data collection condition(s) may not be discarded. The data collection may be terminated when all of the data collection conditions are satisfied.

At step 1912, when the data collection is terminated, the data collection module 1512 may pack the selected (collected) data samples into a package and transfer the package to the online data collection assistance module 1516. In an example, the packages may be transferred through the open fronthaul M-plane. In another example, the packages may be transferred through the O1 interface.

FIG. 20A illustrates an example AI data collection capability report 2000 in accordance with example embodiments of the present disclosure. The example AI data collection capability report 2000 shown in FIG. 20A is for illustration only. Other AI data collection capability reports could be used without departing from the scope of this disclosure.

As shown in FIG. 20A, the AI data collection capability report 2000 may include a list 2002 of associated AI modules 2004 that support the conditional data collection. Optionally, it may report a list of the associated AI modules that support capability of ground truth or pseudo ground truth collection 2006. For each associated AI module 2004, it may also report the support of a pre-collection triggering condition evaluation module 2008, the support of a post-collection condition evaluation module 2010; the supported pre-collection triggering condition evaluation module; and the support of a data sample evaluation module 2012. For example, whether each of the three condition evaluation modules is supported may be indicated by a field 2014, 2016, 2018 as disabled or enabled.

For each supported evaluation module, the report 2000 may include a list 2020, 2022, 2024 of supported KPIs. It may also report a list 2008 of key performance indicators (KPIs), indicating the metrics that can be evaluated for each of the associated AI modules 2004. Alternatively, the KPIs may be specified in a relevant standard specification, and the specified KPIs may be included in the capability report 2000. The online data collection assistance module 1516 may configure the data collection module 1512 with a data collection configuration for each AI module. For example, the supported data collection condition evaluation module can be disabled and the KPI in each KPI list can be down selected.

The online data collection assistance module 1516 may also configure one or more tags as data collection conditions. The tags may include one or more KPIs and one or more collection condition configurations. The supported condition evaluation module may process the one or more tags and a binary indicator may be obtained. The binary indicator can be used for data collection triggering, post-collection data filtering, and post-collection data tagging purposes. The one or more tags can be defined during the capability exchange or with the data collection request configuration.

FIG. 20B illustrates example tags 2010, 2020 for data collection condition evaluation in accordance with example embodiments of the present disclosure. The example tags (data_collection_tag) 2010, 2020 shown in FIG. 20B are for illustration only. Other tags for data collection condition evaluation could be used without departing from the scope of this disclosure.

The data_collection_tag 2010 may include a tag_id 2012, a kpi_list 2014, and a kpi_condition_list 2016. The tag_id 2012 may be unique for each data collection module 1512. When a data_collection_tag 2010 with a tag_id 2012 that has been configured to a data collection module 1512, the data_collection_tag 2010 may be replaced by the latest tag configuration.

The kpi_list 2014 may include one or more KPIs that are commonly understandable by both the online data collection assistance module 1516 and the data collection module 1512. For example, the KPIs may be standardized in the O-RAN or 3GPP standards.

The kpi_condition_list 2016 may be optional and include one or more logical expressions of the KPIs in the kpi_list 2014. The kpi_condition_list 2016 can be used, for example, as following:
The KPI conditions may be connected by the logical “and”. For example, kpi_condition_1 is {kpi_id_1, ‘>10’, ‘or, kpi_id_2,’>10’}; kpi_condition_2 is {kpi_id_3, ‘>=’, −120}. This configuration may be interpreted as: {(kpi_id_1>10 or kpi_id_2>10) and (kpi_id_3>=120)}.
The KPI conditions may be connected by logical “or”. For example, kpi_condition_1 is {kpi_id_1, ‘>10’, ‘or, kpi_id_2,’>10’}; kpi_condition_2 is {kpi_id_3, ‘>=’, −120}. This configuration may be interpreted as: {(kpi_id_1>10 or kpi_id_2>10) or (kpi_id_3>=120)}.

In some embodiments, tags (e.g., the data_collection_tag 2020) may include only a tag_id 2022 and a kpi_condition_list 2026. Examples metrics evaluated using the kpi_condition_list and KPI conditions are illustrated in FIGS. 21A-21B.

FIGS. 21A-21B illustrate examples cases 2110, 2120 in which one or more metrics are evaluated using KPI conditions in accordance with example embodiments of the present disclosure. The example scenarios shown in FIGS. 21A-21B are for illustration only. Other scenarios evaluating different metrics using different collection conditions (KPI conditions) could occur without departing from the scope of this disclosure.

In the example cases 2110, 2120 as shown in FIG. 21A, a RIC 502, 504 may evaluate a base model training dataset and obtain a correlation region of the base model training dataset 2111. In one case 2 110, the RIC 502, 504 may request to collect data 2112 correlated with the base model training dataset 2111 for model fine-tuning. In another case, the RIC 502, 504 may request to collect data 2122 non-correlated with the base model training dataset 2121 for domain adaptation. In these cases 2110 and 2120, the kpi_id_1 may refer to correlation 1 and the kpi_id_2 may refer to the correlation 2. The kpi_condition_list may include one kpi_condition for each of case 1 and case 2. In case 1 2110, the kpi_condition_1 may define a region 2112 inside an ellipsoid, e.g., (kpi_id_1-A)²+(kpi_id_2-B)²+C<0. In case 1 2110, the kpi_condition_1 may also define a region 2114 outside the ellipsoid, e.g., (kpi_id_1-A)²+(kpi_id_2-B)²+C>0.

In the example case 2 130 as shown in FIG. 21B, the AI model 2132 may be used for channel estimation (CE). A base model may be trained with synthetic data 2133. For example, a channel generator 2137 may generate a channel based on a channel model such as a cluster delay line (CDL), 3D-urban macro (UMa), 3D-urban micro (UMi), and/or ray-tracing (RT). In a certain cell, a practical channel may have a different distribution in a certain domain, for example, time correlation and frequency correlation domain. The RIC 502, 504 may blindly request 2134 data collection-for example, the statistics of the cell-specific channel may be unknown. The RIC 502, 504 can also request 2136 to collect data that is correlated to the base model training dataset 2131 in time correlation and frequency correlation domain, or otherwise, by configuring the evaluation domain and region for collection. A supported condition evaluation module (e.g., 1702, 1704, 1706 of FIG. 17) may examine the time correlation and frequency correlation domain of the field channel 2135 and compare them to the required correlation region, then decide to record the data collection or discard.

In this example, the kpi_id_1 may refer to the time correlation and the kpi_id_2 may refer to the frequency correlation. Blind data request 2134 may not require any additional correlation related condition(s). With the correlated data request 2136, the kpi_condition_1 may define a region inside an ellipsoid, e.g., (kpi_id_1-A)²+(kpi_id_2-B)²+C<0. With a non-correlated data request 2138, the kpi_condition_1 may define a region outside an ellipsoid, e.g., (kpi_id_1-A)²+(kpi_id_2-B)²+C>0. The ellipsoid may represent the region of the base model training dataset 2131.

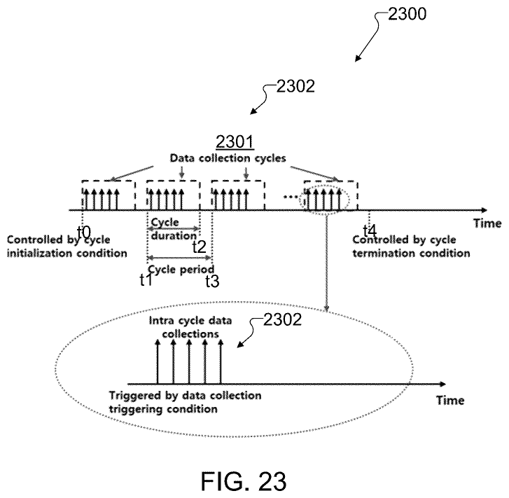

FIG. 22 illustrates an example data collection request 2200 for AI-aided data collection in accordance with example embodiments of the present disclosure. The example data collection request 2200 may be made by using the conditional data collection unit 1500 of FIG. 15. The example data collection request 2200 shown in FIG. 22 is for illustration only. Other data collection requests having different elements or features may be used without departing from the scope of this disclosure.

The online data collection assistance module 1516 may transfer one or more data collection requests 2200 to the data collection module 1512.

As illustrated in FIG. 22, each request (AI_data_collection_request field) 2202 of the one or more data collection requests 2200 may include a request_id field 2203 that may distinguish the request from other requests and be used in a data collection report from the data collection module 1512 to the online data collection assistance module 1516. Each request field 2202 may also include an AI_module_id field 2204 used to identify the AI_module reported during the capability exchange. It may further include a condition configuration (cycle_initialization_condition field) 2206 for data collection initialization, a condition configuration (cycle_termination_condition field) 2208 for data collection termination, and a condition configuration (data_collection_triggering_condition field) 2210 for data collection triggering. The request 2202 may also include a configuration of the content and format of the data collection, and a list (data_collection_tag_list field) 2212 of data collection tag, as an updated supplement of the data collection tags configured during the capability exchange or in a previous data collection request.

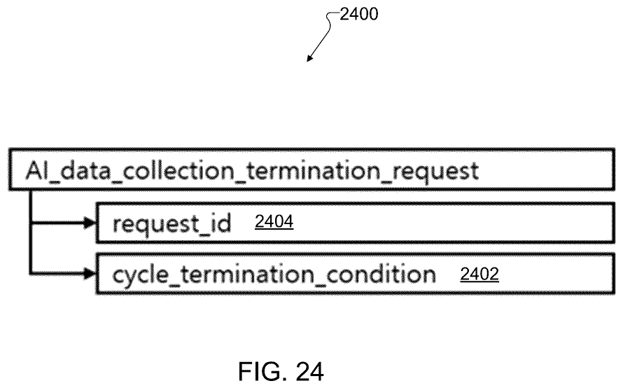

The condition configuration 2206 for the data collection initialization may be configured by the online data collection assistance module 1516. The data collection may have a two-level periodicity as shown in FIG. 23.

Data collection triggering conditions 2210 for each of the three condition evaluations modules 1702, 1704, and 1706 of FIG. 17 may be as following:
Pre-collection triggering condition: A data collection tag with a certain index, e.g. tag_id, may be configured for pre-collection triggering. The conditions of the data collection tag may be evaluated before the data collection. Once the condition(s) is(are) satisfied, the pre-collection trigger may be sent and the data may be collected.
Post-collection condition: A data collection tag with a certain index, e.g. tag_id, may be optionally configured for post-collection triggering. The conditions of the data collection tag may be evaluated after the data collection. Once the condition(s) is(are) satisfied, the data may be retained, otherwise, the collected data may be discarded.
Data collection evaluation: A set of data collection tag with unique indices may be optionally configured for post-collection data evaluation. The data collection tags in the set may be evaluated per collected data samples. If the condition(s) of a data collection tag is(are) satisfied, the collected data sample may be tagged with that data collection tag. The tags may be included in the data collection package that will be transferred to the online data collection helper.

Data collection termination condition 2214 may be configured in various manners. In one alternative, the data collection termination condition 2214 may be absent or configured as ‘none’. The data collection triggering may stop if the data collection cycle is ended. In another alternative, the data collection termination condition 2214 may be configured as ‘count triggering’ with a certain non-negative integer value. Such value may indicate the requested number of data collection triggering. If the number of data collection triggering equals to the configured value, no extra data collection triggering may be performed. If the number of data samples with the configured tag ID is less than to the configured value, however, the data collection cycle may end and the termination condition may not be considered in that data collection cycle.

In another alternative, the data collection termination condition may be configured as ‘count-collected’ with a non-negative integer value. Such value may indicate the maximum number collected data samples. If the number of collected data sample equals to the configured value, no additional data collection triggering may be performed. If the number of data samples with the configured tag ID is less than the configured value, the data collection cycle may end and the termination condition may not be considered in that data collection cycle.

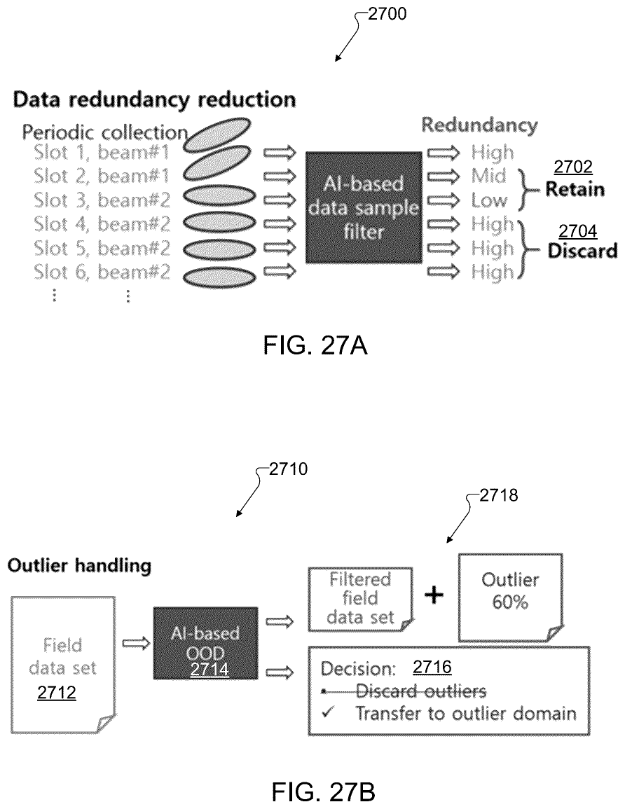

In yet another alternative, the data collection termination condition is configured as ‘count-tag’ with one data collection tag ID, e.g., tag_id, (or a set of data collection tag IDs), with a non-negative integer value. Such value may indicate the requested number of data collection with the configured tag ID. If the number of data samples with the configured tag ID (or all of the tag IDs in the set) equals to the configured value, no additional data collection triggering may be performed. If the number of data samples with the configured tag ID (or with all of the tag IDs in the set) is less than the configured value, the data collection cycle may end and the termination condition may not be considered in that data collection cycle. If the data collection tag is included in any of the data collection triggering condition, the tag need not be reevaluated. If the data collection tag is not included in any of the data collection triggering condition, the collected data sample may be evaluated by this tag, and whether this tag can be tagged to the data samples or not may depend on the configuration. An example scenario in which the data collection termination condition 2214 is configured as a type ‘count-tag’ is illustrated in FIG. 25.

FIG. 23 illustrates an example periodicity 2300 for an AI-aided data collection method in accordance with example embodiments of the present disclosure. The example periodicity 2300 shown in FIG. 23 is for illustration only. Other periodicity for data collection may be used without departing from the scope of this disclosure.

The example periodicity as illustrated in FIG. 23 may have two-levels of periodicity. In the outer-level 2302 of the data collection, one or more data collection cycles 2301 may be configured. The initialization of the data collection cycles 2301 may be controlled by the cycle_initialization_condition field 2206 of FIG. 22.

The data collection cycles may share a common cycle duration and a common cycle period. The initial data collection cycle may begin at time t0. Each data collection cycle 2301 has a cycle duration commencing at time t1 and terminating at time t2. A cycle period between the start of a data collection cycle 2301 and the start of a next data collection cycle 2301 may commence at time t1 and terminate at time t3. The termination of the data collection cycles 2301 may be controlled by the cycle_termination_condition field 2208 of FIG. 22. The data collection cycles 2301 may terminate at time t4.

For example, the data collection cycle periodicity type may be configured as semi-persistent, and the cycle initialization condition may be configured as a certain Monday 8:00 A.M. The cycle termination condition may be configured as a number of performed cycles being equal to 4. The cycle duration may be configured as 2 hours and the cycle period may be configured as 1 day. In this configuration, the data collection module 1512 may perform data collection every day from 9:00 A.M. to 10:00 A.M., commencing on certain Mondays and lasting 4 weeks.

An inner-level 2304 for the data collection and the data collection triggering condition may be configured. The intra cycle data collections 2302 may be triggered by the data_collection_triggering_condition field 2210 of FIG. 22. The end of triggering may be controlled by the data collection termination condition 2214 of FIG. 22.

Two fields of data collection request configuration shown in FIG. 22 may configure the inner-level, i.e., intra cycles, of data collection. For example, the data_collection_triggering_condition 2210 and the data_collection_termination_condition 2214 may configure the triggering condition of performing the data collection within each data collection cycle and the condition of stop of triggering data collection within each cycle, respectively.

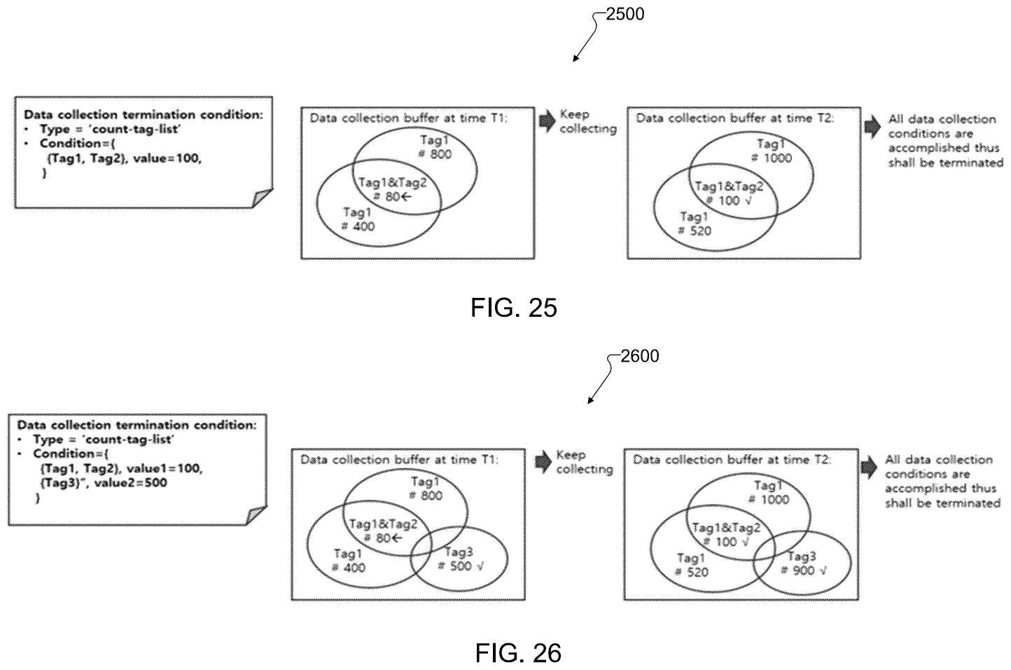

FIG. 24 illustrates an example cycle termination request 2400 in accordance with example embodiments of the present disclosure. The example cycle termination request (AI_data_collection_termination_request field) 2400 shown in FIG. 24 is for illustration only. Other cycle termination request fields may be used without departing from the scope of this disclosure.

Two fields of data collection request configuration shown in FIG. 24 may configure the outer-level cycles of data collection. For example, the cycle_initialization_condition and cycle_termination_condition fields may configure the condition of the start of the first data collection cycle and the condition of the last data collection cycle, respectively. A data collection cycle may be configured by its periodicity type. The periodicity type may be one of periodic, semi-persistent, and aperiodic.

For periodic data collection cycles, the data collection cycles may be launched according to a cycle initialization condition. The data collection cycles may be repeated until an explicit cycle termination request is configured from the online data collection assistance module 1516 to the same data collection module 1512 with the same data collection request ID.

As shown in FIG. 24, the example cycle termination request 2400 may include a cycle_termination_condition field 2402 attached onto a data collection request with the same request ID 2 404.

Semi-persistent type data collection cycles may be launched according to an initialization condition. The data collection cycles may be repeated until the configured cycle termination condition is reached.

An aperiodic type data collection cycle may include only one data collection cycle. The data collection cycles may be launched according to an initialization condition. An aperiodicity type is a special type of semi-persistent data collection cycles with a default cycle termination condition as the number of performed data collection cycle is equal to one.

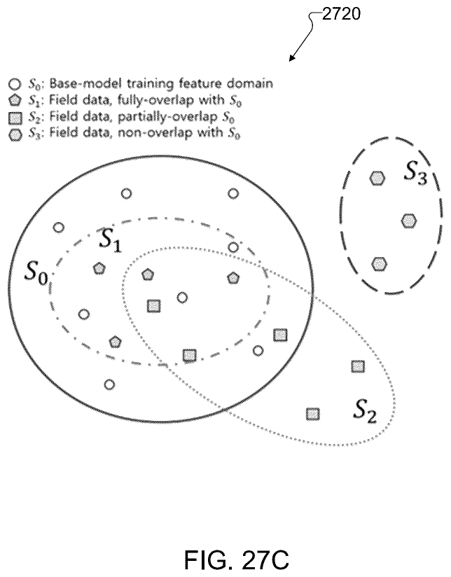

FIG. 25 illustrates an example data collection termination condition 2500 in accordance with example embodiments of the present disclosure. The example data collection termination condition shown in FIG. 25 may be configured as type ‘count-tag’. The example data collection termination condition 2500 is for illustration only. Other data collection termination conditions may be used without departing from the scope of this disclosure as illustrated in FIG. 26.

As shown in FIG. 25, the data collection tag list may include a set of data collection tags (e.g., Tag1 and Tag2) with the value set as 100. At time T1, the number of data samples with Tag1 may be 800 and the number of data samples with Tag2 may be 400. The number of data samples with both Tag1 and Tag2 may be 80. The condition, thus, has not been accomplished, so the collection may not be terminated. At time T2, the number of data samples with Tag1 may be 1000, the number of data samples with Tag2 may be 520, and the number of data samples with both Tag1 and Tag2 may be 100. The condition has been accomplished. The collection may not be terminated.

In one example, only the requested data sample may be packaged and transferred to the online data collection assistance module 1516, i.e., the package may include 100 data sample with Tag1 and Tag2. In another example, all of the data samples may be packaged when the termination condition is accomplished, i.e., the package may include all of the 1000 data samples with Tag1 and the 520 data samples with Tag2. Since one data sample may have multiple tags, the total number of data samples in the package may be less or equal to the summation of 1000, 520. In yet another example, the online data collection assistance module 1516 may configure the data collection module 1512 with the above option to use, for example, in the data collection termination condition or data collection package configuration.

FIG. 26 illustrates another data collection termination condition 2600 in accordance with example embodiments of the present disclosure. The example data collection termination condition shown in FIG. 26 may be configured as the type ‘count-tag-list’. The example data collection termination condition 2600 is for illustration only. Other data collection termination conditions may be used without departing from the scope of this disclosure as shown in FIG. 25.

The example data collection termination condition 2600 may be configured as ‘count-tag-list’ with one or more sets of data collection tag IDs, where each set of data collection tag IDs may be configured with a non-negative integer value. Such value may indicate the requested number of data collection with all of the configured tag IDs in that set. If the number of data samples with all of the configured tag IDs in a set is larger or equal to the configured value, the termination condition of that set may be accomplished. If termination conditions of all of the sets are accomplished, no additional data collection triggering may be performed. If the number of data samples with the configured tag ID is less than the configured value, the data collection cycle may end and the termination condition may not be considered in that data collection cycle.

The data collection termination condition 2600 may include two sets of data collection tags. The first set may include Tag1 and Tag2 with the value (value1) set as 100. The second set may include Tag3 with the value (value2) set as 500. At time T1, the number of data samples with Tag1 may be 800 and the number of data samples with Tag2 may be 400. The number of data samples with both Tag1 and Tag2 may be 80. The number of data samples with Tag3 may be 500. The condition of the first set in the list has not been accomplished, but the condition of the second set in the list has been accomplished. Thus, the collection may not be termination. so the collection may not be terminated. At time T2, the number of data samples with Tag1 may be 1000, the number of data samples with Tag2 may be 520, and the number of data samples with both Tag1 and Tag2 may be 100. The number of data samples with Tag3 may be 900. The condition of the first set in the list has been accomplished, and the condition of the second set in the list has been accomplished. Thus, the collection may not be terminated. The collection may not be terminated.

In one example, only the requested data samples may be packaged and transferred to the online data collection assistance module 1516 of FIG. 15. That is, the package may include 100 data samples with Tag1 and Tag2, and 500 data samples with Tag3. Since the data samples may have Tag1, Tag2, and Tag3, together, the total number of data samples in the package may be less or equal to the summation of 100 and 500. In another example, all of the data samples may be packaged when the termination condition is accomplished, i.e., the package includes all of the 1000 data samples with Tag1, 520 data samples with Tag2, and 900 data samples with Tag3. Since one data sample may have multiple tags, the total number of data samples in the package may be less or equal to the summation of 1000, 520, and 900. In yet another example, the online data collection assistance module may configure the data collection module 1512 with the above option to use, for example, in the data collection termination condition or data collection package configuration.

Data collection package configuration may be configured by the online data collection assistance module 1516. The online data collection assistance module 1516 may configure the components of the data collection. The online data collection assistance module 1516 may configure one or more components from the list below:
AI module input data
AI module output data
(pseudo) ground truth data
Data collection tag(s) that is(are):
   used in pre-collection triggering condition
   used in post-collection condition
   used in post-collection evaluation
Measurement: KPI with index and measured values, e.g. SNR, interference plus noise power (IpN), timing advance, frequency offset, etc.
Scheduling information: contextual information related to the collected data sample, e.g., timing information, such as frame index, slot index, time stamp, etc.; number of configured MIMO users, MCS, etc.

The online data collection assistance module 1516 may configure the format of the data collection. In one example, the collected components may be a list in a given sequence in a data package. In another example, multiple input-output data component pairs may be requested to be in one data package. One measurement data (for example) may be included and shared for all the input-output data. In another example, the compression method(s) of the components may be configured. The online data collection assistance module 1516 may receive the collected data and store in memory. In another example, the collected data may be directly stored in the memory. In another example, the collected data may be unpacked and reconstructed to a certain required format, and then stored in the memory. In another example, the received collected data may be filtered before storing in the memory. For instance, an outlier detection may be applied to remove the corrupted data.

FIGS. 27A-27C illustrate example data filtering and training set generation techniques 2700, 2710, 2720 in accordance with example embodiments of the present disclosure. The example data filtering and training set generation techniques 2700, 2710, 2720 shown in FIGS. 27A-27C are for illustration only. Other data filtering and training set generation techniques 2700, 2710, 2720 may be used without departing from the scope of this disclosure.

The example data filtering and training set generation technique 2700 shown in FIG. 27A is associated with a beam selection. The data filter may be applied to capture relevant (meaningful and/or useful) data samples for further model fine-tuning or retraining. For example, the data samples 2702 closest to a beam switching may be retained, but the data samples 2704 collected while the beam remains unchanged may be discarded.

The example data filtering and training set generation technique 2710 may identify an outlier (out-of-distribution (OOD)) 2714 based on the collected field dataset 2712. The training strategy and training dataset may rely on the outlier evaluation. For example, if the outlier ratio is low (e.g. lower than a threshold), the target AI model may be fine-tuned based on the outlier-removed dataset 2716. If the outlier ratio is high (e.g. higher than a threshold), the target AI model may be retrained 2718 with the outliers, which is cell-specific data and needs to be adapted.

The non-outlier data can be reduced so that the training may be focused on the outlier adaptation.

The example data filtering and training set generation techniques 2720 shown in FIG. 27C may resolve a misalignment between a base model training dataset and collected field dataset.
S₀ represents the base model training dataset feature domain. Note that while a 2-dimensional feature domain is used in FIG. 27C, the feature domain selection and dimension may depend on field knowledge and designs.
S₁ represents a scenario in which the collected field data set is included in the base model training dataset with a different distribution. In this case, the model fine-tuning or retraining may adapt the model capability, focusing on the feature domain region S₁.
S₂ represents a scenario in which the collected field data set is partially deviated from the base model training dataset, yet set with a different distribution. However, S₂ indicates the existence of outliers and the training may be thus expected to adapt the target AI model to further support the outliers.
S₃ represents a scenario in which the collected field data set is totally deviated from the base model training dataset. The model retraining may be needed with the training dataset, which may be mainly from S₃.

To resolve the misalignment case of S₁, in one example, the training dataset for fine-tuning and retraining an AI model may be from the collected field data. The module controlling the training process, e.g., the offline AI module manager 622 of FIG. 6, may be optional to generate synthetic training samples, which may be the feature domain aligned with S₁. In another example, the training dataset for fine-tuning and retraining an AI model may be from the collected field data and the base model training dataset. The module controlling the training process, e.g., the offline AI module manager 622, may determine the ratio of the field collected dataset and the base model training dataset. Optionally, the offline AI module manager 622 may generate synthetic training samples, which may be the feature domain aligned with S₀ and S₁ to a determined amount and ratio.

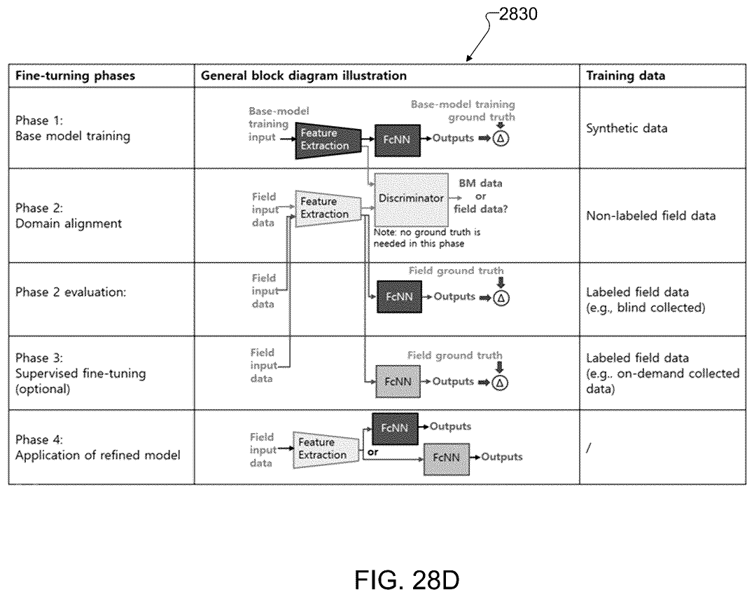

To resolve the misalignment case of S₁ and S₂, example solutions may be provided as illustrated in FIGS. 28A-28D.

FIGS. 28A-28D illustrate example solutions 2800, 2810, 2820, 2830 to misalignment case of S₁ and S₂ of FIG. 27C in accordance with example embodiments of the present disclosure. Note that the example solutions 2800 and 2810 may relate to feature domain expansion and the example solutions 2820 and 2830 may relate to feature space shifting. However, the example solutions 2800, 2810, 2820, 2830 are for illustration only, and other solutions to misalignment scenarios may be used without departing from the scope of this disclosure.

In an example solution 2800 as illustrated in FIG. 28A, the training dataset may include synthetic training samples together with the base model training dataset and the field collected dataset. The three parts of the training dataset (i.e., the synthetic training samples together with base model training data and field collected data) may include an enlarged region in the targeted feature domain. The module controlling the training process, e.g., the offline AI module manager 622 of FIG. 6, may determine the distribution of the training samples in the training dataset so that fine-tuning or retraining of the target AI model may be effectively achieved.

In an example solution 2810 (for AI based channel estimation) as shown in FIG. 28B, the module controlling the training process, e.g., the offline AI module manager 622, may analyze the field collected dataset in the feature domain, which includes, e.g., delay spread, angular spread, path loss per clusters, etc. The module controlling the training process may generate a determined amount of synthetic training samples using, for example, a CDM (clustered delay line) channel model, based on the knowledge of the region of the base model training dataset and the field collected dataset in that feature domain. The final training set may include synthetic training samples together with base model training dataset and the field collected dataset.

In an example solution 2820 as illustrated in FIG. 28C, the field collected data set may be remapped so that the remapped data set has an improved alignment with the base model training data set.

In another example solution 2830 as illustrated in FIG. 28D, a generative adversarial network (GAN) may help the remapping of the field collected data set to the base model training data set. In such an example, the training procedure may be utilized for AI/ML model fine-tuning. The AI/ML model may be split into two parts. One may be a feature extraction network defining feature domain; and the other may be the rest of the entire network generating the desired output. As shown in FIG. 28D, in Phase 1, the first part of the entire network may be a feature extraction connecting to the input and the second part may be a fully connected neural network (FcNN) connecting to the output.

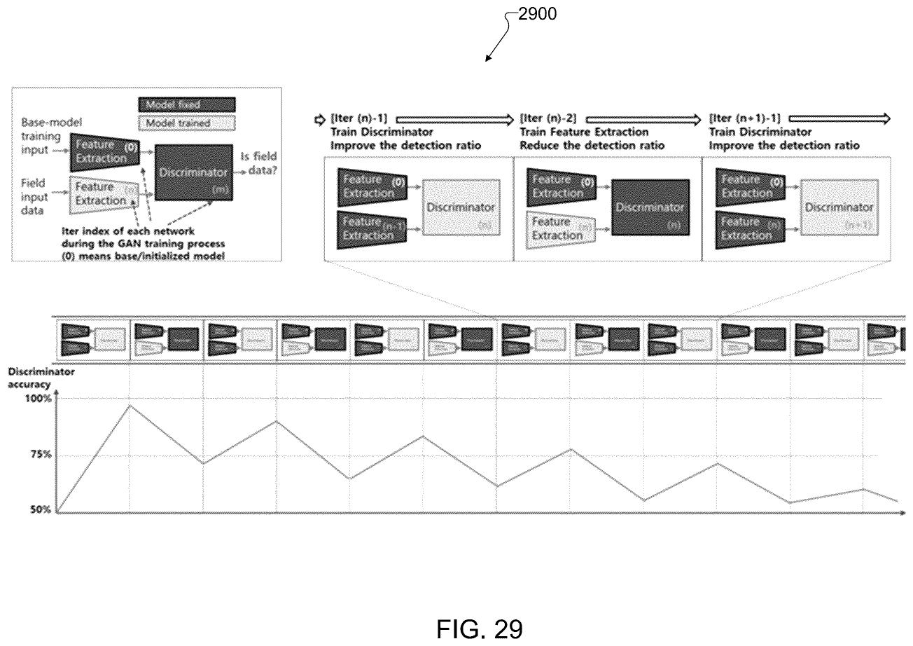

The two parts may be fine-tuned in different manners. In Phase 1, the base model may be trained. Synthetic data and/or field collected data may be used for the model training. In Phase 2, a GAN may be used for the training of the feature extraction network. The feature extraction network of the base model as well as a discriminator network may be used in this phase. The feature extraction network of the base model may not be trainable. The discriminator network may be used only in this phase. The feature extraction network and the discriminator may be trained alternatively as illustrated in FIG. 29.

The input of the extraction in the base model may be the base model training set. The input of the feature extraction to be trained may be from the field data set. The input of the discriminator network may include a mixed output of both feature extraction networks. The output of the discriminator network may be the prediction of whether the input is generated by the feature extraction network inputted with the field collected data or the feature extraction network inputted with the base model training data. This means that phase 2 may need non-labeled data, i.e., the field collected data need in the phase 2 may only include the input and the ground truth may not be needed.

The training of the discriminator may aim to improve the accuracy of discriminating the feature extraction networks inputted with the base model training data versus filed collected data. When the discriminator is being trained, both feature extraction networks may be frozen, i.e., not being trained. When training the discriminator, the end-of-training condition could be:
The accuracy may be saturated and not increasing
The accuracy may increase by a determined amount, e.g., 10%.
After a certain # of epochs, e.g., 20.

The training of the feature extraction network inputted with the field collected data may aim to reduce the accuracy of discriminating the feature extraction networks inputted with the base model training data versus the field collected data. When the feature extraction network inputted with the field collected data is being trained, both the feature extraction network inputted with base model training data and the discriminator may be frozen, i.e., not being trained. When training the feature extraction network inputted with field collected data, the end-of-training condition could be:
The accuracy is saturated and not increasing
The accuracy increases by a determined amount, e.g., 10%.
After a certain # of epochs, e.g., 20.

The networks (e.g., the FcNN) may be evaluated upon training in Phase 2. The effectiveness of the untrained FcNN with the trained feature extraction network may be evaluated in this phase. The evaluation may need labeled field collected data. In the following cases:
If the performance satisfies a certain requirement, the FcNN may not need to be fine-tuned, the phase 3 may be omitted, the fine-tuned feature extraction network with FcNN from the base model may be treated as the fine-tuned model in phase 4.
If the performance does not satisfy a certain requirement, the FcNN may need fine-tuning. Phase 3 may be performed. In an alternative, the module controlling the training process, e.g., the offline AI module manager 622, may analyze the performance and request field data with specific conditions and amounts of one or more specified portions.

If Phase 3 is performed, the FcNN may be fine-tuned using labeled field collected data or specifically generated training data set. In the following cases:
If the performance satisfies a certain requirement, the fine-tuned feature extraction network with the fine-tuned FcNN may be treated as the fine-tuned model in phase 4.
If the performance does not satisfy a certain requirement, the base model may be used in phase 4. The fine-tuning or retraining may be considered.

In Phase 4, the AI/ML model may be updated if performance requirement is satisfied in phase 2 or Phase 3. Otherwise, the model may not be updated.

FIG. 29 illustrates an example training process 2900 of the generative adversarial network of FIG. 28D in accordance with example embodiments of the present disclosure. The example training process 2900 is for illustration only. Other data collection termination conditions may be used without departing from the scope of this disclosure.

As illustrated in FIG. 29, the input of the extraction in the base model may be the base model training set. The input of the feature extraction to be trained may be from the field data set. The input of the discriminator network may include a mixed output of both feature extraction networks. The output of the discriminator network may be the prediction of whether the input is generated by the feature extraction network inputted with the field collected data or the feature extraction network inputted with the base model training data.

Each network may include an iteration index during the GAN training process 2900 with zero indicating the base and/or initialized model. At iteration (n)−1, the discriminator is trained to improve the detection ratio. At iteration (n)−2, the feature extraction network may be trained to reduce the detection ratio. At iteration (n+1)−1, the discriminator may be trained to improve the detection ratio.

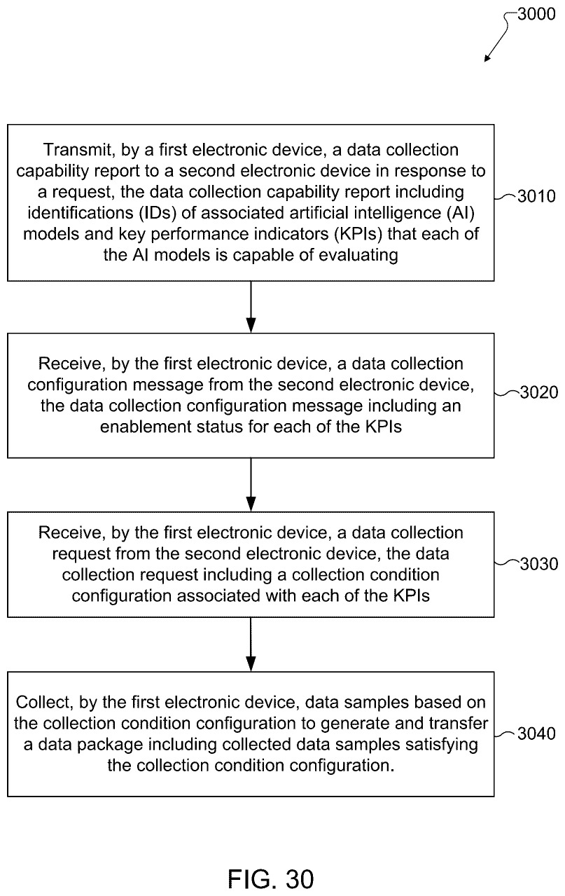

FIG. 30 illustrates an example flow chart for an AI-aided data collection method 3000 in accordance with example embodiments of the present disclosure. An embodiment of the method illustrated in FIG. 30 is for illustration only. One or more of the components illustrated in FIG. 30 may be implemented in specialized circuitry configured to perform the noted functions or one or more of the components may be implemented by one or more processors executing instructions to perform the noted functions. Other embodiments of data preparation could be used without departing from the scope of this disclosure.

As illustrated in FIG. 30, the method 3000 begins at step 3010. At step 3010, a first electronic device (e.g., a base station 101-103 of FIGS. 1 and 2, an O-RU 512 or an O-DU 510 in FIG. 5) may transmit a data collection capability report to a second electronic device (e.g., an RIC 502, 504 of FIG. 5) in response to a request. The request may be made by the RIC 502, 504. The data capability report may include identifications (IDs) of associated artificial intelligence (AI) models and key performance indicators (KPIs) that each of the AI models is capable of evaluating.

At step 3020, the first electronic device may receive a data collection configuration message from the second electronic device. The data collection configuration message may include an enablement status for each of the KPIs.

At step 3030, the first electronic device may receive a data collection request from the second electronic device. The data collection request may include a collection condition configuration associated with each of the KPIs.

In one embodiment, where the collection condition configuration includes collection conditions and a tag ID of each of the collection conditions, the first electronic device may determine whether each of the collected data samples satisfies the collection conditions, discard collected data samples that fail to satisfy one or more of the collection conditions, tag collected data samples satisfying the one or more of the collection conditions, and store tagged data samples until each of the collection conditions is satisfied.

In one embodiment, where the collection condition configuration includes collection conditions and a tag ID of each of the collection conditions and the collection conditions include at least one of a pre-collection condition or a post-collection condition, the first electronic device may determine whether the pre-collection condition is satisfied, and in response to a determination that the pre-collection condition is satisfied, trigger to collect data samples based on the collection condition configuration. The first electronic device may further determine whether the collected data samples satisfy the post-collection condition, discard collected data samples that fail to satisfy the post-collection condition, tag the collected data samples satisfying the collection condition configuration, and generate the data package. Alternatively, the first electronic device may further determine whether the collected data samples satisfy the collection condition configuration, discard collected data samples that fail to satisfy the collection condition configuration, tag the collected data samples satisfying the collection condition configuration, and generate the data package.

In one embodiment, where the collection condition configuration includes a collection window, collection conditions and a tag ID of each of the collection conditions, and each collection condition includes a predefined number of data samples to be collected for the collection condition, the first electronic device may determine whether the predefined number for each collection condition has been reached, in response to a determination that the predefined number has not been reached for each collection condition, collect data samples until the predefined number of each collection condition is reached or the collection window lapses; and terminate evaluation of collected data samples for satisfied collection conditions.

At step 3040, the first electronic device may collect data samples based on the collection condition configuration to generate and transfer a data package including collected data samples satisfying the collection condition configuration.

In one embodiment, the data collection capability report, the request, the data collection configuration message, the data collection request and the data package may be transmitted though O1 interface or an open fronthaul M-plane.

In one embodiment, the AI models may be trained by: filtering, by the second electronic device, collected field data to remove at least one of redundancy or out-of-distribution data; generating, by the second electronic device, a training dataset using the filtered field data; tuning, by the second electronic device, hyperparameters for the AI models; fine-tuning, by the second electronic device, a base model based on the identified hyperparameters and the training dataset; and transferring, by the second electronic device, the fine-tuned base model to the first electronic device to update the AI models.

In one embodiment, the AI models may be trained by aligning field data with a feature domain of a base model training dataset. The field data may be aligned by: training, by the second electronic device, a base model based on synthetic data, the base model including a feature extraction network and a fully connected neural network; refining, by the second electronic device, the feature extraction network based on non-labeled field data using a generative adversarial network; evaluating, by the second electronic device, the feature extraction network with the fully connected neural network using labeled field collected data; refining, by the second electronic device, the fully connected neural network based on the evaluation and the labeled field collected data to generate a fined-tuned base model; and updating, by the first electronic device, the AI models using the fined-tuned base model.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
transmitting, by a first electronic device, a data collection capability report to a second electronic device in response to a request, the data collection capability report including identifications (IDs) of associated artificial intelligence (AI) models and key performance indicators (KPIs) that each of the AI models is capable of evaluating;
receiving, by the first electronic device, a data collection configuration message from the second electronic device, the data collection configuration message including an enablement status for each of the KPIs;
receiving, by the first electronic device, a data collection request from the second electronic device, the data collection request including a collection condition configuration associated with each of the KPIs; and
collecting, by the first electronic device, data samples based on the collection condition configuration to generate and transfer a data package including collected data samples satisfying the collection condition configuration.

2. The method of claim 1, wherein:
the collection condition configuration comprises collection conditions and a tag ID of each of the collection conditions; and
the method further comprises:
determining, by the first electronic device, whether each of the collected data samples satisfies the collection conditions;
discarding, by the first electronic device, collected data samples that fail to satisfy one or more of the collection conditions;
tagging, by the first electronic device, collected data samples satisfying the one or more of the collection conditions; and
storing, by the first electronic device, tagged data samples until each of the collection conditions is satisfied.

3. The method of claim 1, wherein:
the collection condition configuration comprises collection conditions and a tag ID of each of the collection conditions, the collection conditions including at least one of a pre-collection condition or a post-collection condition; and
the method further comprises at least one of:
determining, by the first electronic device, whether the pre-collection condition is satisfied,
in response to a determination that the pre-collection condition is satisfied, triggering, by the first electronic device, to collect data samples based on the collection condition configuration; and
determining, by the first electronic device, whether the collected data samples satisfy the post-collection condition, discarding collected data samples that fail to satisfy the post-collection condition, tagging the collected data samples satisfying the collection condition configuration, and generating the data package, or
determining, by the first electronic device, whether the collected data samples satisfy the collection condition configuration, discarding collected data samples that fail to satisfy the collection condition configuration, tagging the collected data samples satisfying the collection condition configuration, and generating the data package.

4. The method of claim 1, wherein:
the collection condition configuration comprises a collection window, collection conditions and a tag ID of each of the collection conditions, each collection condition including a predefined number of data samples to be collected for the collection condition; and
the method further comprises:
determining, by the first electronic device, whether the predefined number for each collection condition has been reached;
in response to a determination that the predefined number has not been reached for each collection condition, collecting, by the first electronic device, data samples until the predefined number of each collection condition is reached or the collection window lapses; and
terminating, by the first electronic device, evaluation of collected data samples for satisfied collection conditions.

5. The method of claim 1, wherein the data collection capability report, the request, the data collection configuration message, the data collection request and the data package are transmitted though O1 interface or an open fronthaul M-plane.

6. The method of claim 1, wherein the AI models are trained by:
filtering, by the second electronic device, collected field data to remove at least one of redundancy or out-of-distribution data;
generating, by the second electronic device, a training dataset using the filtered field data;
tuning, by the second electronic device, hyperparameters for the AI models;
fine-tuning, by the second electronic device, a base model based on the identified hyperparameters and the training dataset; and
transferring, by the second electronic device, the fine-tuned base model to the first electronic device to update the AI models.

7. The method of claim 1, wherein:
the AI models are trained by aligning field data with a feature domain of a base model training dataset; and
aligning the field data comprises:
training, by the second electronic device, a base model based on synthetic data, the base model including a feature extraction network and a fully connected neural network;
refining, by the second electronic device, the feature extraction network based on non-labeled field data using a generative adversarial network;
evaluating, by the second electronic device, the feature extraction network with the fully connected neural network using labeled field collected data;
refining, by the second electronic device, the fully connected neural network based on the evaluation and the labeled field collected data to generate a fined-tuned base model; and
updating, by the first electronic device, the AI models using the fined-tuned base model.

8. A first electronic device comprising:
memory; and
a processor operably coupled to the memory, the processor configured to:
transmit a data collection capability report to a second electronic device in response to a request, the data collection capability report including identifications (IDs) of associated artificial intelligence (AI) models and key performance indicators (KPIs) that each of the AI models is capable of evaluating;
receive a data collection configuration message from the second electronic device, the data collection configuration message including an enablement status for each of the KPIs;
receive a data collection request from the second electronic device, the data collection request including a collection condition configuration associated with each of the KPIs; and
collect data samples based on the collection condition configuration to generate and transfer a data package including collected data samples satisfying the collection condition configuration.

9. The first electronic device of claim 8, wherein:
the collection condition configuration comprises collection conditions and a tag ID of each of the collection conditions;
the processor is further configured to:
determine whether each of the collected data samples satisfies the collection conditions;
discard collected data samples that fail to satisfy one or more of the collection conditions; and
tag collected data samples satisfying the one or more of the collection conditions; and
the memory is configured to store tagged data samples until each of the collection conditions is satisfied.

10. The first electronic device of claim 8, wherein:
the collection condition configuration comprises collection conditions and a tag ID of each of the collection conditions, the collection conditions including at least one of a pre-collection condition or a post-collection condition; and
the processor is further configured to:
determine whether the pre-collection condition is satisfied,
in response to a determination that the pre-collection condition is satisfied, trigger to collect data samples based on the collection condition configuration; and
determine whether the collected data samples satisfy the post-collection condition, discard collected data samples that fail to satisfy the post-collection condition, tag the collected data samples satisfying the collection condition configuration, and generate the data package, or
determine whether the collected data samples satisfy the collection condition configuration, discard collected data samples that fail to satisfy the collection condition configuration, tag the collected data samples satisfying the collection condition configuration, and generate the data package.

11. The first electronic device of claim 8, wherein:
the collection condition configuration comprises a collection window, collection conditions and a tag ID of each of the collection conditions, each collection condition including a predefined number of data samples to be collected for the collection condition; and
the processor is further configured to:
determine whether the predefined number for each collection condition has been reached;
in response to a determination that the predefined number has not been reached for each collection condition, collect data samples until the predefined number of each collection condition is reached or the collection window lapses; and
terminate evaluation of collected data samples for satisfied collection conditions.

12. The first electronic device of claim 8, wherein the data collection capability report, the request, the data collection configuration message, the data collection request and the data package are transmitted though O1 interface or an open fronthaul M-plane.

13. The first electronic device of claim 8, wherein the AI models are trained by:
filtering, by the second electronic device, collected field data to remove at least one of redundancy or out-of-distribution data;
generating, by the second electronic device, a training dataset using the filtered field data;
tuning, by the second electronic device, hyperparameters for the AI models;
fine-tuning, by the second electronic device, a base model based on the identified hyperparameters and the training dataset; and
transferring, by the second electronic device, the fine-tuned base model to the first electronic device to update the AI models.

14. The first electronic device of claim 8, wherein:
the AI models are trained by aligning field data with a feature domain of a base model training dataset; and
aligning the field data comprises:
training, by the second electronic device, a base model based on synthetic data, the base model including a feature extraction network and a fully connected neural network;
refining, by the second electronic device, the feature extraction network based on non-labeled field data using a generative adversarial network;
evaluating, by the second electronic device, the feature extraction network with the fully connected neural network using labeled field collected data;
refining, by the second electronic device, the fully connected neural network based on the evaluation and the labeled field collected data to generate a fined-tuned base model; and
updating, by the first electronic device, the AI models using the fined-tuned based model.

15. A non-transitory computer readable medium embodying a computer program, the computer program comprising program code that, when executed by a processor of a first electronic device, causes the first electronic device to:
transmit a data collection capability report to a second electronic device in response to a request, the data collection capability report including identifications (IDs) of associated artificial intelligence (AI) models and key performance indicators (KPIs) that each of the AI models is capable of evaluating;
receive a data collection configuration message from the second electronic device, the data collection configuration message including an enablement status for each of the KPIs;
receive a data collection request from the second electronic device, the data collection request including a collection condition configuration associated with each of the KPIs; and
collect data samples based on the collection condition configuration to generate and transfer a data package including collected data samples satisfying the collection condition configuration.

16. The non-transitory computer readable medium of claim 15, wherein:
the collection condition configuration comprises collection conditions and a tag ID of each of the collection conditions;
the non-transitory computer readable medium further comprises the program code that, when executed by the processor of the first electronic device, causes the first electronic device to:
determine whether each of the collected data samples satisfies the collection conditions;
discard collected data samples that fail to satisfy one or more of the collection conditions;
tag collected data samples satisfying the one or more of the collection conditions; and
store tagged data samples until each of the collection conditions is satisfied.

17. The non-transitory computer readable medium of claim 15, wherein:
the collection condition configuration comprises collection conditions and a tag ID of each of the collection conditions, the collection conditions including at least one of a pre-collection condition or a post-collection condition; and
the non-transitory computer readable medium further comprises the program code that, when executed by the processor of the first electronic device, causes the first electronic device to:
determine whether the pre-collection condition is satisfied,
in response to a determination that the pre-collection condition is satisfied, trigger to collect data samples based on the collection condition configuration; and
determine whether the collected data samples satisfy the post-collection condition, discard collected data samples that fail to satisfy the post-collection condition, tag the collected data samples satisfying the collection condition configuration, and generate the data package, or
determine whether the collected data samples satisfy the collection condition configuration, discard collected data samples that fail to satisfy the collection condition configuration, tag the collected data samples satisfying the collection condition configuration, and generate the data package.

18. The non-transitory computer readable medium of claim 15, wherein:
the collection condition configuration comprises a collection window, collection conditions and a tag ID of each of the collection conditions, each collection condition including a predefined number of data samples to be collected for the collection condition; and
the non-transitory computer readable medium further comprises the program code that, when executed by the processor of the first electronic device, causes the first electronic device to:
determine whether the predefined number for each collection condition has been reached;
in response to a determination that the predefined number has not been reached for each collection condition, collect data samples until the predefined number of each collection condition is reached or the collection window lapses; and
terminate evaluation of collected data samples for satisfied collection conditions.

19. The non-transitory computer readable medium of claim 15, wherein the AI models are trained by:
filtering, by the second electronic device, collected field data to remove at least one of redundancy or out-of-distribution data;
generating, by the second electronic device, a training dataset using the filtered field data;
tuning, by the second electronic device, hyperparameters for the AI models;
fine-tuning, by the second electronic device, a base model based on the identified hyperparameters and the training dataset; and
transferring, by the second electronic device, the fine-tuned base model to the first electronic device to update the AI models.

20. The non-transitory computer readable medium of claim 15, wherein:
the AI models are trained by aligning field data with a feature domain of a base model training dataset; and
aligning the field data comprises:
training, by the second electronic device, a base model based on synthetic data, the base model including a feature extraction network and a fully connected neural network;
refining, by the second electronic device, the feature extraction network based on non-labeled field data using a generative adversarial network;
evaluating, by the second electronic device, the feature extraction network with the fully connected neural network using labeled field collected data;
refining, by the second electronic device, the fully connected neural network based on the evaluation and the labeled field collected data to generate a fined-tuned base model; and
updating, by the first electronic device, the AI models using the fined-tuned based model.
